(19) United States
(12) Patent Application Publication
(10) Pub. No.: US 2005/0142305 A1
(43) Pub. Date: Jun. 30, 2005

(54) Ink jet recording sheet and method for producing thereof

(76) Inventors: Mitsuru Kobayashi, Fujisawa-shi (JP); Ikuko Furukawa, Amagasaki-shi (JP); Hirotake Fujita, Amagasaki-shi (JP); Tetsuo Tsuchida, Takarazuka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/979,449

(22) Filed: Nov. 2, 2004

(30) Foreign Application Priority Data
Nov. 6, 2003 (JP) 2003-376675
Dec. 19, 2003 (JP) 2003-422773

(51) Int. Cl. B41M 5/00

(52) U.S. Cl. 428/32.34

(57) ABSTRACT

Ink jet recording sheet having excellent glossiness, ink absorptivity, image quality, and long-term preservability in which cracks generated on an ink receiving layer are significantly reduced. The ink jet recording sheet includes a supporting medium; and an ink receiving layer including an inorganic fine particle, a cationic polymer, and a binder, wherein an average primary particle size of the inorganic fine particle is 30 nm or less, and the cationic polymer including: at least one structural unit (a1) expressed by a following general formula (1) or (2): 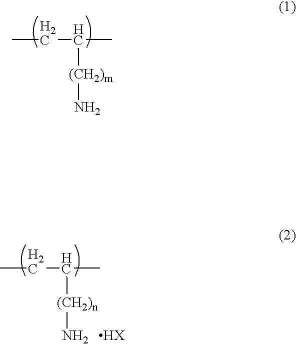
wherein m and n independently represents an integer of 0 to 4, and X represents an acid residue; and at least one structural unit (a2) expressed by a following general formula (3), (4), (5) or (6): 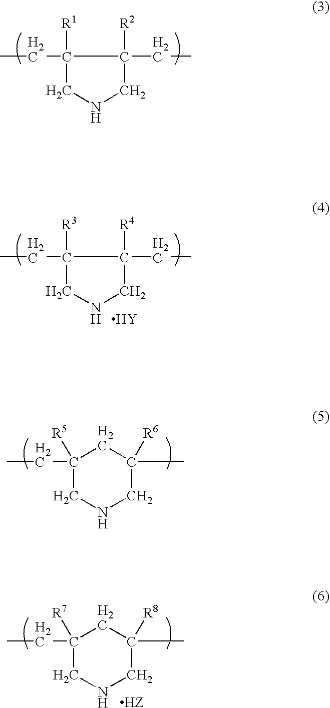
wherein R¹ to R⁸ independently represents a hydrogen atom or a C1-C4 alkyl group, and Y and Z independently represents an acid residue.

### BACKGROUND OF THE INVENTION

1. Field of the Invention

The present invention relates to ink jet recording sheet having an ink receiving layer, which includes inorganic fine particles, cationic polymer, and binder, disposed on a supporting medium, and a method for manufacturing the ink jet recording sheet.

2. Description of Related Art

Ink jet recording systems in which aqueous ink is ejected through a nozzle having fine pores to form an image on a recording medium is widely used in terminal printers, facsimiles, plotters, sheet feeding printers, etc., due to low noise during recording, ease of performing color recording, possibility of performing high-speed recording, lower cost than other printing devices, and so forth.

Recently, demand has also increased for high performance of recording medium which is used in an ink jet recording system due to increasing widespread use of printers and development thereof to enhance high definition and high-speed performance as well as appearance for digital cameras in the field. That is, recording medium having excellent recording properties including a high ink absorptivity, a high recording density, a high water resistance and preservability, and a high image quality equivalent to a silver halide photograph is strongly awaited.

In order to improve ink absorptivity, recording density, and image quality, a method has been proposed in which inorganic fine particle, such as amorphous silica, is disposed, as an ink receiving layer, on a supporting member together with a binder (for example, refer to Japanese Laid-open Patent Application No. Sho 55-51583, Japanese Laid-open Patent Application No. Sho 56-157, Japanese Laid-open Patent Application No. Sho 57-107879, Japanese Laid-open Patent Application No. Sho 57-1078880, Japanese Laid-open Patent Application No. Sho 59-230787, Japanese Laid-open Patent Application No. Sho 62-183382, Japanese Laid-open Patent Application No. Sho 62-184879, and Japanese Laid-open Patent Application No. Sho 64-11877.) Also, a method in which synthesized silica fine particle is used in an ink receiving layer in order to improve glossiness and image quality of a recording medium has been proposed.

Also, methods have been proposed in which various additives are added, such as a method in which at least one of metallic oxide, metallic chloride, and tannic acid, such as phosphotungstic acid, phosphomolybdic acid, and chromic chloride, is added in order to improve the preservability of an image, a method in which antioxidant, such as a hindered phenol, is added, a method in which ultraviolet absorbent, such as a benzophenone, a benzotriazole and a phenylsalicylic acid, is added, a method in which thiourea compound is added, a method in which a particular mercapto compound, such as 2-mercapto benzothiazole and 2-mercaptobenzimidazole, is added, a method in which dithiocarbamate, thiuramate, thiocyanic ester or thiocyanate is added, a method in which basic polyalminium hydroxide is added, and a method in which zirconyl oxychloride type active inorganic polymer is added.

Moreover, methods have been proposed in which cationic polymer or basic latex is included in ink receiving layer in order to improve the recording density or the water resistance of an image. As an example of the cationic polymer, a primary amine polymer having a structural unit derived from a primary amine, such as monoallyl amine, a secondary amine polymer having a structural unit derived from a secondary amine, such as diallyl amine, a quaternary ammonium polymer having a structural unit derived from a quaternary ammonium compound, such as diallyldimethylammonium chloride, and a primary amine/secondary amine copolymer having a structural unit derived from primary amine salt and diallyl amine salt have been proposed (refer to, for example, Japanese Laid-open Patent Application No. Sho 60-83882, Japanese Laid-open Patent Application No. Sho 61-61887, and Japanese Laid-open Patent Application No. Sho 62-238783.)

Furthermore, as ink jet recording paper which is excellent in glossiness, ink absorptivity, light resistance and water resistance, Japanese Laid-open Patent Application No. 2000-211235, for example, discloses ink jet recording sheet having an ink receiving layer which includes vapor phase silica and a quaternary ammonium cationic polymer having a diallylamine derivative, such as diallyldimethylammonium chloride, as a structural unit, disposed on a water resistant supporting member.

However, although full-color ink jet recording image formed by using ink jet recording sheet disclosed in Japanese Laid-open Patent Application No. Sho 60-83882, Japanese Laid-open Patent Application No. Sho 61-61887, and Japanese Laid-open Patent Application. No. Sho 62-238783 has high printing density, and is excellent in water resistance and light resistance of an image, it is not sufficient for glossiness, ink absorptivity, image quality, long-term preservability, and in particular, preservability under high temperature and humidity environment (high temperature and humidity resistance).

Also, full-color ink jet recording image formed by using ink jet recording sheet disclosed in Japanese Laid-open Patent Application No. 2001-211235 has problems in high temperature and humidity resistance, light resistance, ozone resistance, and so forth similar to that disclosed in Japanese Laid-open Patent Application No. Sho 60-83882, and the ink absorptivity thereof is also insufficient.

Moreover, the surface of ink receiving layer of the ink jet recording sheet obtained by using the above technique tends to be easily cracked, and hence, has problems in that the glossiness of the sheet decreases and the quality of the image is deteriorated.

### SUMMARY OF THE INVENTION

Accordingly, an object of the present invention includes to provide an ink jet recording sheet in which the problem of cracks generated on the ink receiving layer is significantly eliminated, and is excellent in all of the glossiness, ink absorptivity, image quality, and long-term preservability, and a method for producing the ink jet recording sheet.

The inventors of the present invention found that the glossiness, ink absorptivity, image quality, and so forth may be improved by using inorganic fine particles having an average primary particle size of 30 nm or less as inorganic fine particles to be included in an ink receiving layer.

However, when such an inorganic fine particle is used in combination with cationic polymer, aggregation, etc., of the inorganic fine particle is caused. Accordingly, lowering in printing density and cracks on an ink receiving layer, which are conventionally observed, are more markedly caused, and as a result, problems, such as lowering in glossiness or image quality is caused. Also, with regard to the long-term preservability of an image, in particular to the high temperature and humidity resistance and light resistance, sufficient improvement thereof cannot be obtained.

The inventors of the present invention have found, after diligent studies, that the above problems may be solved by using an inorganic fine particle having an average primary particle size of 30 nm or less in combination with cationic polymer having a particular structural unit and by forming an ink receiving layer with a plurality of layers between which an aqueous coating layer formed by coating an aqueous solution including cationic compound is incorporated, and completed the present invention.

Accordingly, the present invention includes the following aspects:

(1) Ink jet recording sheet which includes: a supporting medium; and an ink receiving layer including an inorganic fine particle, a cationic polymer, and a binder, the ink receiving layer being disposed on the supporting medium, wherein an average primary particle size of the inorganic fine particle is 30 nm or less, and the cationic polymer is a polymer (A) including: at least one structural unit (a1) expressed by a following general formula (1) or (2): 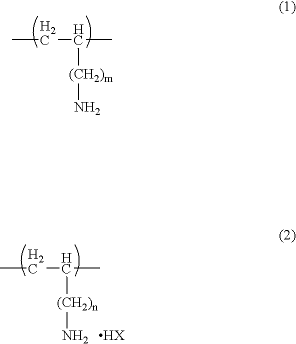
wherein m and n independently represents an integer of 0 to 4, and X represents an acid residue; and at least one structural unit (a2) expressed by a following general formula (3), (4), (5) or (6): 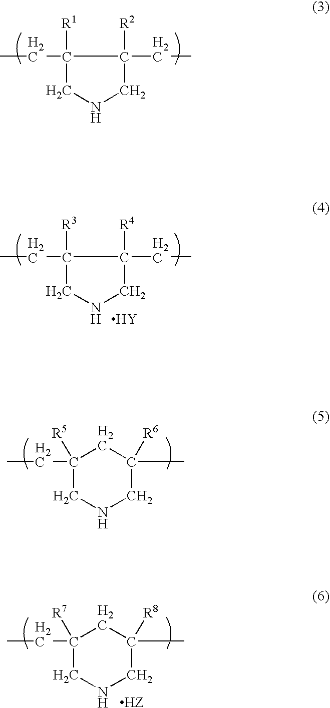
wherein R¹ to R⁸ independently represents a hydrogen atom or an alkyl group having a number of carbon atoms of 1 to 4, and Y, and Z independently represents an acid residue.

(2) The ink jet recording sheet according to (1), wherein the molar ratio of the structural unit (a1) to the structural unit (a2) in the polymer (A) is within a range of 0.5:1 to 5:1.

(3) The ink jet recording sheet according to (1), wherein each of m and n in the formula (1) or (2) represents 1.

(4) The ink jet recording sheet according to (1), wherein each of R¹ to R⁸ in the formula (3), (4), (5) or (6) represents a hydrogen atom.

(5) The ink jet recording sheet according to (1), wherein the polymer (A) further including a structural unit expressed by a following general formula (7):

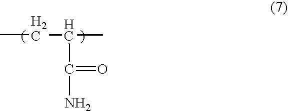

(6) The ink jet recording sheet according to (1), wherein a total of the structural unit (a1) and the structural unit (a2) in the polymer (A) is 50% by mass or more with respect to the polymer (A).

(7) The ink jet recording sheet according to (1), wherein a molecular weight of the polymer (A) is within a range of 10,000 to 200,000.

(8) The ink jet recording sheet according to (1), wherein the inorganic fine particle is vapor phase silica.

(9) The ink jet recording sheet according to (1), wherein the inorganic fine particle is wet process fine silica prepared by condensing active silica.

(10) The ink jet recording sheet according to (9), wherein a specific surface area measured by a BET method and a pore volume of the wet process fine silica is 100 to 400 m²/g and 0.5 to 2.0 ml/g, respectively.

(11) The ink jet recording sheet according to (1), wherein the ink receiving layer further includes a cross-linking agent.

(12) The ink jet recording sheet according to (11), wherein the cross-linking agent includes a boron compound.

(13) The ink jet recording sheet according to (12), wherein a mass ratio of the boron compound to the polymer (A) in the ink receiving layer is 1:1 to 1:10.

(14) The ink jet recording sheet according to (1), wherein the supporting medium is a water resistant supporting medium.

(15) The ink jet recording sheet according to (14), wherein the water resistant supporting medium is a member at least one surface of which is coated by a polyolefin resin.

(16) The ink jet recording sheet according to (1), wherein the ink receiving layer is subjected to a cast process.

(17) The ink jet recording sheet according to (1), further including a glossy layer which is disposed on the ink receiving layer.

(18) The ink jet recording sheet according to (1), wherein the ink receiving layer is made of a plurality of layers including: at least one inside layer including an inorganic fine particle and a binder; at least one aqueous coating layer formed on the inside layer by applying an aqueous solution including a cationic polymer on the inside layer; and at least one outside layer disposed on the aqueous coating layer.

(19) The ink jet recording sheet according to (18), wherein the aqueous solution further includes a cross-linking agent.

(20) A method for producing an ink jet recording sheet, including the steps of: forming at least one inside ink receiving layer including an inorganic fine particle and a binder on a supporting medium; applying an aqueous solution including a cationic compound onto the inside ink receiving layer to form at least one aqueous coating layer; and forming at least one outside ink receiving layer including an inorganic fine particle and a binder on the aqueous coating layer.

(21) The method according to (20), wherein the aqueous solution further includes a cross-linking agent.

(22) The method according to (21), wherein the cross-linking agent includes a boron compound.

(23) The method according to (20), wherein the cationic compound is at least one selected from the group consisting of a cationic polymer, water soluble aluminum compound, and water soluble zirconyl compound.

(24) The method according to (20), wherein content of the cationic compound in the aqueous coating layer is 0.01 to 10 g/m².

(25) The method according to (20), wherein the cationic compound is a polymer (A) including: at least one structural unit (a1) expressed by a following general formula (1) or (2): 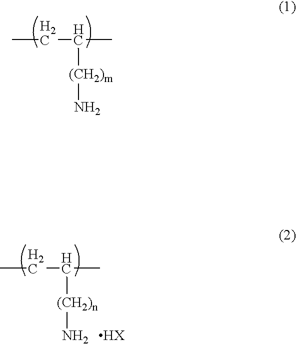
wherein m, and n independently represents an integer of 0 to 4, and X represents an acid residue; and at least one structural unit (a2) expressed by a following general formula (3), (4), (5) or (6): 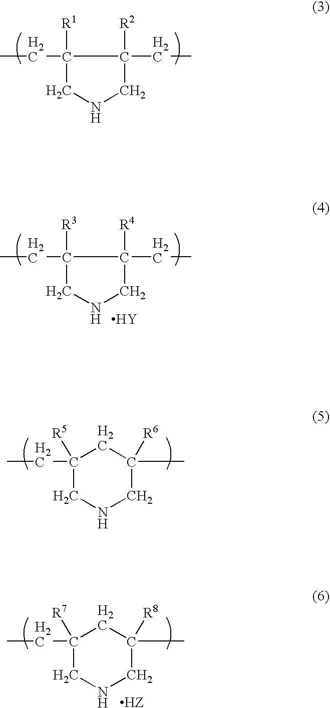
wherein R¹ to R⁸ independently represents a hydrogen atom or an alkyl group having a number of carbon atoms of 1 to 4, and Y and Z independently represents an acid residue.

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementation of the invention, is not intended to limit the enumerated claims, but to serve as particular examples thereof.

Hereinafter, the present invention will be explained in detail.

The ink jet recording sheet of the present invention has an ink receiving layer which includes inorganic fine particle, cationic polymer, and binder disposed on a supporting medium.

Supporting Medium

As a supporting medium, a known medium for conventional ink jet recording paper may be suitably used.

More specifically, examples of the supporting medium includes paper (acidic paper, neutralized paper), baryta paper, synthetic paper, plastic film, a supporting medium in which one or both surfaces of paper are covered by plastic (RC paper), and a medium in which nonwoven fabric or plastic film is adhered to one or both surfaces of paper via adhesive.

Examples of the plastic film include polyolefin resin, such as polyester and polypropylene, and film, such as nylon.

Among these, it is preferable to use water resistant supporting medium by which ink does not permeate through the supporting medium in order to obtain clear image of high density.

As a water resistant supporting medium, one in which both surfaces of paper is coated by polyolefin resin is preferably used since its recording image is similar to a photographic image and a high quality image may be obtained at low cost.

Although the thickness of the supporting medium is not particularly limited, it is preferably 100 to 400 μm, for example.

Ink Receiving Layer Inorganic Fine Particle

According to the present invention, the ink receiving layer includes inorganic fine particles having an average primary particle size of 30 nm or less. By including the inorganic fine particle having an average primary particle size of 30 nm or less, an ink receiving layer whose transparency is high and is excellent in print density, glossiness, and ink absorptivity may be obtained. The primary particle size of the inorganic fine particle is more preferably between 3 to 15 nm.

Note that the term “primary particle size” used in the present specification means a particle size (Martin's diameter) observed by electron microscope (SEM and TEM).

Examples of materials for the inorganic fine particle contained in the ink receiving layer include zeolite, soft calcium carbonate, heavy calcium carbonate, magnesium carbonate, kaolin, talc, calcium sulfate, barium sulfate, titanium oxide, zinc oxide, zinc sulfide, zinc carbonate, satin white, aluminum silicate, diatomaceous earth, calcium silicate, magnesium silicate, silica, aluminum hydroxide, alumina, hydrated alumina, alumino silicate, boehmite, and pseudoboehmite. Among them, silica, alumina, hydrated alumina, and alumino silicate are preferable from the viewpoint of ink absorptivity, and silica is particularly preferable.

Also, it is preferable that the inorganic fine particle has a specific surface area measured by the BET method of 100 m²/g or more. Although there is no upper limit for the BET specific surface area, it is preferably about 1000 m²/g or less. The BET specific surface area is more preferably about 200 to 400 m²/g.

The BET method used in this specification is one of the surface measuring methods by a vapor phase adsorption, and is a method for obtaining a total surface area of one gram sample, i.e., specific surface area, from absorption isotherm.

Although the average secondary particle size of the inorganic fine particle when the primary particles thereof are aggregated to form aggregated particles (secondary particles) is not particularly limited, it is preferably 0.05 to 1.0 μm, and more preferably 0.05 to 0.5 μm.

The amount of inorganic fine particle used in the ink receiving layer is preferably 20 to 90% by mass, and more preferably 30 to 80% by mass, with respect to the solid components of the ink receiving layer. Note that when the amount of the inorganic fine particle is in the above-mentioned range, there is no danger that the coating strength of the ink receiving layer is lowered, and excellent ink absorptivity, ink drying property, and high quality image may be obtained.

According to the present invention, as mentioned above, silica is preferably used as the inorganic fine particle. Silica may be mainly separated into two categories of natural silica which may be obtained by pulverizing natural silica, such as quartz, and synthetic silica which may be manufactured by synthesis. The synthetic silica may be further separated into vapor phase silica and wet process silica. According to the present invention, wet process fine silica which will be described later is preferably used among the vapor phase silica and the wet process silica from the viewpoint of obtaining high ink absorptivity, transparency, and glossiness.

The vapor phase silica is also called dry process silica in relation to the wet process silica, and may be produced by flame hydrolysis. More specifically, it is produced by heating silicon tetrachloride with hydrogen and oxygen. Silane, such as methyltrichlorosilane and trichlorosilane, may be used singularly instead of silicon tetrachloride or in mixture with silicon tetrachloride. The vapor phase silica is commercially available as powder of very low bulk density.

When an aqueous dispersion of vapor phase silica is dried, it becomes porous silica gel and the volume of fine pores thereof measured by the BET method is generally 1.2 to 1.6 ml/g. This volume of fine pores is convenient for absorbing ink. However, cracks are often generated when dried, and it is not easy to produce ink receiving layer of no cracks.

As wet process silica, one which is produced by sedimentation method and one which is produced by gel method is known.

The sedimentation method silica is produced by adding mineral acid to a silicic acid alkali aqueous solution stepwise and filtering the precipitated silica as disclosed in Japanese Laid-open Patent Application No. Sho 55-116613, for example.

The gel method silica is produced by mixing mineral acid with a silicic acid alkali aqueous solution to form gel and then washing and pulverizing it.

In the sedimentation method silica and the gel method silica, its primary particle is bonded each other to form secondary particles. Accordingly, a number of voids are formed between the primary particles and the secondary particles, and hence a large amount of ink may be absorbed. Also, since its property of scattering light is small, a high print density may be obtained.

Moreover, as an example of wet process silica which is produced by a somewhat special method, there is fine silica which is produced by condensing active silica (hereinafter referred to as wet process fine silica) as disclosed in U.S. Pat. No. 2,574,902, Japanese Laid-open Patent Application No. 2001-354408, and Japanese Laid-open Patent Application No. 2002-145609. Here, the term “active silica” means a silicic acid aqueous solution of pH 4 or less obtained by subjecting an alkali metal silicate aqueous solution to ion exchanging process using hydrogen type cation exchange resin.

The wet process fine silica disclosed in U.S. Pat. No. 2,574,902 is produced by preparing an active silica aqueous solution by treating diluted aqueous solution of sodium silicate with a cation exchange resin to remove sodium ions, then adding alkali to a part of the active silica aqueous solution so as to be polymerized in a stable manner to form a dispersion (a seed solution) in which seed particles of silica are dispersed, and gradually adding the rest of the active silica aqueous solution (a feed solution) thereto while maintaining an alkali condition to polymerize silicic acid so as to grow the particle of colloidal silica.

The fine silica has a diameter of 3 nm to a few hundred nanometers, and is characterized by not forming secondary aggregation and having an extremely narrow particle size distribution. It is generally called a colloidal silica, and a product of 7 nm to 10 nm is commercially available as an aqueous dispersion. When this is used for an ink receiving layer, one which has excellent glossiness and transparency can be obtained.

The wet process fine silica disclosed in Japanese Laid-open Patent Application No. 2001-354408, on the other hand, is silica fine particle obtained by “a method of producing silica fine particle dispersion in which silica fine particle having a BET specific surface area of 100 m²/g to 400 m²/g, an average secondary particle size of 20 nm to 300 nm, and a pore volume of 0.5 ml/g to 2.0 ml/g is dispersed in a colloidal manner, characterized by adding alkali to a seed solution in which silica fine particle having a BET specific surface area of 300 m²/g to 1000 m²/g, and a pore volume of 0.4 ml/g to 2.0 ml/g is dispersed in a colloidal manner, and then adding little by little a small amount of a feed solution including at least one selected from an active silica aqueous solution and alkoxy silane so as to grow silica fine particle” or by “a method of producing silica fine particle dispersion in which silica fine particle having a BET specific surface area of 100 m²/g to 400 m²/g, an average secondary particle size of 20 nm to 300 nm, and a pore volume of 0.5 ml/g to 2.0 ml/g is dispersed in a colloidal manner, characterized by adding little by little a small amount of a mixture of alkali and a feed solution including at least one selected from an active silica aqueous solution and alkoxy silane or adding little by little a small amount of the feed solution and an alkali at the same time to a seed solution in which silica fine particle having a BET specific surface area of 300 m²/g to 1000 m²/g, and a pore volume of 0.4 ml/g to 2.0 ml/g is dispersed in a colloidal manner so as to grow silica fine particle”.

Also, the wet process fine silica disclosed in Japanese Laid-open Patent Application No. 2002-145609 is silica fine particle obtained by “a method of producing silica fine particle dispersion in which suspension including aggregate of silica fine particle is formed by heating an aqueous solution including at least one selected from active silica and alkoxy silane, and after silica fine particle in the suspension is grown by adding little by little a small amount of at least one of an aqueous solution including an active silica and alkoxy silane to the suspension in the presence of alkali, the suspension is subjected to wet grinding.

The wet process fine silica disclosed in Japanese Laid-open Patent Application No. 2001-354408 and Japanese Laid-open Patent Application No. 2002-145609 is a silica which possesses advantages of sedimentation process silica and gel process silica together with advantages of colloidal silica. This silica is most preferably used in the present invention since it is of secondary particle formed by bonding primary particles of silica (for example, the above-mentioned colloidal silica) and it is easy to adjust the size of the secondary particle to be the wavelength of light or less so that an ink receiving layer having excellent ink absorption amount and glossiness may be readily produced. Hereinafter the wet process fine silica is called secondary fine silica.

Among these, the secondary fine silica which is produced by a condensation method disclosed in Japanese Laid-open Patent Application No. 2001-354408 is preferably used in the present invention since secondary fine silica having the above-mentioned average secondary particle size (20 nm to 300 nm) and the pore volume (0.5 ml/g to 2.0 ml/g) may be directly produced without depending on the mechanical means and the particles size distribution thereof is narrow so that excellent transparency, glossiness, etc., of ink receiving layer may be obtained.

In the condensation method disclosed in Japanese Laid-open Patent Application No. 2001-354408, a silicic acid aqueous solution of pH 4 or less obtained by subjecting an alkali metal silicate aqueous solution to an ion exchanging process using hydrogen type cation exchange resin (active silica aqueous solution), for example, is preferably used as an active silica.

The concentration of the active silica aqueous solution, in terms of SiO₂ concentration, is preferably 1 to 6% by mass, more preferably 2 to 5% by mass, and pH thereof is preferably 2 to 4.

As a method for condensing active silica, it is preferable to grow a primary particle of a seed particle by adding the above-mentioned active silica aqueous solution to hot water or by heating the active silica aqueous solution, then adding alkali before precipitation is caused in the dispersion or the dispersion is gelled so as to stabilize the seed particle, and adding the active silica aqueous solution preferably at a rate of 0.001 to 0.2 mol/min in terms of SiO₂ with respect to 1 mol of SiO₂ contained in the seed particle while maintaining the stable sate.

Also, it is preferable that the wet process fine silica have a BET specific surface area of 100 to 400 m²/g and a pore volume of 0.5 to 2.0 ml/g. These fine silica are excellent in preventing cracks from being generated on ink receiving layer, and in balance of ink absorptivity and glossiness.

Moreover, a silica-cationic compound aggregated fine particle having an average particle size of 0.7 μm or less, which is obtained by mixing and aggregating amorphous silica and a cationic compound and pulverizing a resulting silica-cationic compound aggregated particle, is preferably used in an outer ink receiving layer.

By using the silica-cationic compound aggregated fine particle, it becomes possible to make the ink receiving layer a porous layer having excellent transparency, ink absorptivity, coloring of ink, weatherbility, and so forth.

The silica-cationic compound aggregated fine particle is a silica colloid particle solution including secondary particle which is substantially formed by aggregating primary particles. For the case of silica sol in which primary particles are monodispersed (for example, generally available colloidal silica), a porous layer obtained by being coated on a substrate becomes relatively dense, and hence its transparency is readily deteriorated and a large amount thereof must be coated in order to obtain sufficient ink absorption property. However, if a large amount of the silica sol is coated, cracks are readily generated on the coating and a coating process tends to become complicated. Primary particles may be partially included in a silica colloide particle solution.

According to the present invention, if the silica-cationic compound aggregated particle is included in the ink receiving layer together with binder (polyvinyl alcohol is particularly preferable), transparency is obtained for printed portions, and glossiness equivalent to photographic level may be obtained. Also, since the entire ink receiving layer is transparent, it may be used as an OHP sheet and so forth.

As mentioned above, the silica-cationic compound aggregated fine particle having an average particle size of 0.7 μm or less is obtained by mixing and aggregating an amorphous silica and a cationic compound and pulverizing the resulting silica-cationic compound aggregated particle.

The silica-cationic compound aggregated fine particle means a state of fine particles having an average particle size of 0.7 μm or less and a maximum particles size of about 1000 nm or less are uniformly dispersed.

The silica-cationic compound aggregated fine particle may be obtained by adding a strong force to a mixture of silica and a cationic compound by a mechanical means. That is, the fine particle may be obtained by a breaking down method (a method for fractionating a bulk material). The silica-cationic compound aggregated fine particle may be in the form of slurry. The mechanical means may be an ultrasonic, a high-speed mill, a roller mill, a vessel driving medium mill, a medium agitation mill, a jet mill, a sand grinder, and so forth.

All of the average particle sizes used in the present invention are particle sizes measured under electron microscope (SEM and TEM). That is, electron micrographs having a magnification of 10,000 to 400,000 times are taken and Martin's diameter of particles within 5 cm² are measured and averaged (refer to “Fine Particle Handbook”, Asakura Shoten, p. 52 (1991), etc.)

The average particle size of the silica-cationic compound aggregated fine particle (substantially a secondary particle) is adjusted to be 0.7 μm or less, preferably 10 to 300 nm, and more preferably 20 to 200 nm. If the silica-cationic compound aggregated fine particle having an average particle size of more than 0.7 μm is used, there is a danger that the transparency and print density thereof is significantly reduced and that ink jet recording sheet having high transparency after printing cannot be obtained. On the other hand, if silica colloid particle having an extremely small average particle size is used, there is a danger that a sufficient ink absorption rate cannot be obtained.

It is preferable that the amorphous silica which forms the silica-cationic compound aggregated fine particle has an average primary particle size of 3 nm to 40 nm. If the average primary particle size is less than 3 nm, voids present between the primary particles become significantly small. On the other hand, if the average primary particle size exceeds 40 nm, the size of aggregated secondary particle becomes large and there is a danger that the transparency of ink receiving layer is reduced.

As a cationic compound used for the silica-cationic compound aggregated fine particle, various known cationic compounds which are generally used for ink jet paper may be used. Examples of the cationic compounds include a primary amine type cationic polymer having a primary amine salt as a structural unit, such as monoallyl amine salt, vinyl amine salt, N-vinyl acrylamidine salt, dicyandiamide.formalin polycondensation products, and dicyandiamide.polyethyleneamine polycondensation products; a secondary amine type cationic polymer having a secondary amine salt as a structural unit, such as diallylamine salt and ethyleneimine salt; a tertiary amine type cationic polymer having a tertiary amine salt as a structural unit, such as diallylmethylamine salt; a quaternary ammonium type cationic polymer having a quaternary ammonim salt as a structural unit, such as diallyldimethylammoniumchloride, (meth)acryloyloxyethyltrimethylammoniumchloride, (meth)acrylamidepropyltrimethyl ammoniumchloride, dimethylamine.epichlorohydrin polycondensation product, aluminum compounds, such as basic aluminum polychloride, and basic aluminum polyfatty acids; and zirconyl compounds, such as zirconyl chloride, basic zirconyl chloride and zirconylium fatty acid. Also, it is possible to use two or more of these cationic compounds in combination. Note that the amount of the cationic compound added is adjusted to be 1 to 30 parts by mass, more preferably 5 to 20 parts by mass, with respect to 100 parts by mass of amorphous silica.

According to the present invention, when the silica-cationic compound aggregated fine particle is used as an inorganic fine particle, PVA is most effective as a binder from the viewpoints of proper dispersion and coating stability. In particular, PVA having a polymerization degree of 2,000 or more is preferably used in order to obtain suitable dispersion and ink absorption. The polymerization degree of PVA is more preferably between 2,000 and 5,000. Also, PVA having 95% or more of saponification degree is effective for obtaining an appropriate water resistance.

Although the ratio of solid content mass of the silica-cationic compound aggregated fine particle to the binder is not particularly limited, it is adjusted to be within the range of 10/1 to 10/10, more preferably within the range of 10/2 to 10/6. If the amount of binder added is too large, pore size between particles becomes small and a sufficient ink absorption rate may not be obtained. On the other hand, if the amount of binder added is too small, cracks may be generated on the coating layer and may become practically inapplicable.

Cationic Polymer

The cationic polymer used in the present invention is a polymer (hereinafter referred to as polymer (A)) including at least one structural unit (a1) expressed by the above general formula (1) or (2) and at least one structural unit (a2) expressed by the above general formula (3), (4), (5) or (6).

According to the present invention, the problem of cracks on the ink receiving layer is significantly solved by adding the polymer (A) to the ink receiving layer together with the above-mentioned inorganic fine particle having an average primary particle size of 30 nm or less. The reason for this may be related to the aggregation of inorganic fine particles or the precipitation of cationic polymer in a coating solution of the ink receiving layer are inhibited. Also, according to the present invention, the glossiness of the ink receiving layer as well as the ink absorption property thereof may be enhanced. Moreover, the quality of an image formed on the ink receiving layer and the long-term preservability thereof may be improved.

In the general formula (1) and (2), m and n represent, independent of each other, an integer of 0 to 4, preferably 1.

In the general formula (3) to (6), R¹ to R⁸ represent, independent of each other, a hydrogen atom or an alkyl group having a number of carbon atoms of 1 to 4. From the viewpoint of availability and resistance to crack generation, it is preferable that all of R¹ to R⁸ represent a hydrogen atom.

In the general formula (2), (4) and (6), X, Y and Z each represents, independent of each other, an acid residue, and the acid thereof (HX, HY, HZ, HW) may be inorganic acids or organic acids. Specific examples of the inorganic acid include hydrochloric acid, sulfuric acid, nitric acid, phosphoric acid, pyrophosphoric acid, and metaphosphoric acid, and specific examples of the organic acid include formic acid, acetic acid, propionic acid, methane sulfonic acid, and p-toluene sulfonic acid. Among these acids, hydrochloric acid, sulfuric acid, and methanesulfonic acid are especially effective for image preservabilitity and hence preferable.

Specific examples of the structural unit (a1) expressed by the general formula (1) or (2) include a structural unit which possesses a primary amine having a vinyl alkyl group, such as vinyl amine, allyl amine, vinylethyl amine, and vinyl butyl amine or an acid salt thereof as a monomer.

Specific examples of the structural unit (a2) expressed by the general formula (3), (4), (5) or (6) include a structural unit which possesses a secondary amine having two vinyl alkyl groups, such as diallyl amine, di(2-methyl allyl)amine and di(2-ethylallyl)amine or an acid salt thereof as a monomer.

Among these, a cationic polymer in which the structural unit (a1) includes allyl amine or acid salt thereof as a monomer and the structural unit (a2) includes diallyl amine or acid salt thereof as a monomer, is preferable since an image of high quality is obtained and the preservability thereof such as high temperature and humidity resistance, light resistance, ozone resistance, and so forth are excellent.

The molar ratio of the structural unit (a1) to the structural unit (a2) in the polymer (A) is preferably in the range between 0.1:1 to 10:1, and more preferably 0.5:1 to 5:1. If the molar ratio is within this range, it becomes possible to improve the ink receiving layer so that an image of high quality and an excellent long-term preservability are particularly obtained.

The polymer (A) may have a structural unit (a3) other than the above-mentioned structural unit (1) to (6).

As the structural unit (a3), a structural unit having a known ethylenically unsaturated compound as a monomer, which is capable of copolymerizing the monomer of the structural unit (1) to (6), may be utilized.

Specific examples of the structural unit (a3) include a structural unit including, as a monomer, acrylamide, methacrylamide, N-methylacrylamide, N,N-dimethylacrylamide, N-ethylacrylamide, N-isopropylacrylamide, diacetoneacrylamide, N-methylolacrylamide, N, N-dimethylacrylamide, N,N-dimethylaminopropylacrylamide, acroylmorpholine, N-vinylpyrrolidone, hydroxyethyl acrylate, hydroxyethyl methacrylate, methoxyethyl acrylate, vinyl acetate, N-vinyl formamide, acrylonitrile, acrylic acid, methyl acrylate, ethyl acrylate, and so forth.

Among these, a structural unit having acrylamide as a monomer, i.e., the structural unit expressed by the above formula (7), is preferable because the problem of cracks generated on the ink receiving layer may be solved and the preservability, such as light resistance and ozone resistance, may further be improved.

In order to exert the effect of the present invention in a more marked manner, it is preferable that the total amount of the structural unit (a1) and the structural unit (a2) in the polymer (A) is 50% by mass or more with respect to the weigh of the polymer (A).

The molecular weight of the polymer (A) used in the present invention is preferably within the range between 5,000 to 500,000, and more preferably between 10,000 to 200,000. If the molecular weight thereof is within this range, image quality, preservability, such as light resistance and high temperature and humidity resistance, and ink absorption become excellent, and the problem of cracks is also improved.

The amount of the above-mentioned cationic polymer in the ink receiving layer is preferably within the range of 0.01 to 10 g/m², more preferably 0.05 to 5 g/m². If the amount thereof is within this range, an image quality and the preservability of image become excellent.

Although methods for including the polymer (A) used in the present invention into an ink receiving layer is not particularly limited, examples thereof include a method in which the polymer is added in an ink receiving layer coating solution and then coated on a supporting medium, a method in which an aqueous solution thereof is coated prior to coating the ink receiving layer, and a method in which an aqueous solution is applied after the ink receiving layer is coated.

Among these methods, for the case where the ink receiving layer is made of a plurality of layers, it is preferable that after at least one layer of the ink receiving layers (an inside ink receiving layer) is formed, an ink receiving layer solution is applied thereon so that at least one other ink receiving layer (an outside ink receiving layer) is formed. The method is more effective for improving the high temperature and humidity resistance of an image, and the effect of inhibiting generation of cracks is also high.

It is preferable to add a cross-linking agent to an aqueous solution including the polymer (A) from the viewpoint of inhibiting the generation of cracks.

Specific examples of the cross-linking agent include boron compounds, such as boric acid, borax and borate, glyoxzal, melamine.formaldehyde, gultaraldehyde, methylol urea, polyisocyanate compounds, epoxy compounds, aziridine compounds, carbodiimido compounds, dihidrazide compounds, aluminum compounds, zirconyl compounds, and so forth. Among these, boron compounds are preferable, and borax is particularly preferable.

By adding a mixed solution of borax and the polymer (A), it becomes possible to particularly improve the high temperature and humidity resistance, and the crack generation inhibitory effect may also be improved.

Also, it is preferable to adjust pH of the mixed solution within the range of 7.0 to 10.0, more preferably 7.5 to 9.0 prior to use since it is effective for preventing the generation of cracks.

In this case, the amount of the cross-linking agent applied is preferably 0.01 to 1.0 g/m², more preferably 0.05 to 0.5 g/m². If the amount is less than 0.01 g/m², the effect of preventing the generation of cracks is reduced, and if it exceeds 1.0 g/m², on the other hand, there is a danger that bending or breaking of the ink receiving layer may be caused due to strong constriction generated during drying and that the ink absorption property thereof may be lowered.

Also, the mass ratio of the cross-linking agent to the polymer (A) is preferably within the range between 1:1 to 1:20, and more preferably 1:1 to 1:10. If the mass ratio is within this range, ink jet recording sheets which are excellent in time-lapse feathering resistance and ink absorption property may be obtained.

Moreover, although examples of methods of applying the polymer (A) to an ink receiving layer coating solution used in the present invention include a method in which it is added when inorganic fine particles are dispersed, a method in which it is added to a final coating solution, etc., it is preferable to determine the adding method, and the order of addition by taking into account the stability of coating solution, and so forth.

According to the present invention, it is possible to use various known cationic polymers other than the polymer (A) if it does not interfere with the effect of the present invention.

Binder

Examples of the binder which may be contained in the ink receiving layer include starch derivatives, such as oxidized starch and etherified starch; cellulose derivatives, such as carboxymethyl cellulose and hydroxyethyl cellulose; proteins, such as casein, gelatin and soy bean proteins; polyvinyl alcohols, such as completely (or partially) saponificated polyvinyl alcohol, silicon denatured polyvinyl alcohol, acetoacetyl group denatured polyvinyl alcohol and cation denatured polyvinyl alcohol; aqueous adhesives, such as salt of styrene-maleic anhydride copolymer, styrene-butadiene latex, acryl latex, polyester-polyurethane latex, and vinyl acetate latex; and organic solvent soluble resin, such as polymethacrylate, polyurethane resin, unsaturated polyester resin, vinyl chloride-vinyl acetate copolymer, polyvinyl butyral, and alkyd resin. These binders may be used singularly or in a mixture of two or more.

Among the above binders, polyvinyl alcohols are preferable in terms of their high transparency and water resistance, non-ionic property which makes them capable of mixing with various material, and relatively low swelling at room temperature. Also, polyvinyl alcohols have advantages in that they do not swell and clog pores when ink is initially permeated.

Among polyvinyl alcohols, completely (or partially) saponificated polyvinyl alcohol, cation denatured polyvinyl alcohol, and silicon denatured polyvinyl alcohol are particularly suitable.

As the completely (or partially) saponificated polyvinyl alcohol, a partially saponificated polyvinyl alcohol having a saponification degree of 80% or more, particularly 95% or more, or a completely saponificated polyvinyl alcohol is preferable, and its average polymerization degree is preferably in the range between 200 and 5,000, and more preferably between 500 and 5,000.

The reason why a completely (or partially) saponificated polyvinyl alcohol having a saponification degree of 80% or more is preferable is because such polyvinyl alcohol possesses a superior water resistance. Also, the reason why the average polymerization degree of 200 to 5,000 is preferable is because an excellent water resistance and viscosity of easy-handling may be obtained when one having such polymerization degree is used.

Also, as a cation denatured polyvinyl alcohol, one having a primary, secondary, or tertiary amino group or a quaternary ammonium salt group in a main chain or a branched chain of polyvinyl is preferable.

The amount of binder is preferably 1 to 100 parts by mass, more preferably 5 to 50 parts by mass, with respect to 100 parts by mass of inorganic fine particle.

Other Components

According to the present invention, it is preferable to use the above-mentioned binder together with the above-mentioned cross-linking agent. In this manner, it becomes possible to reduce the generation of cracks and to improve the ink absorptivity, glossiness, image quality, and so forth.

The cross-linking agent may be included in a coating solution for forming the ink receiving layer, or a solution including the cross-linking agent may be coated before or after coating an ink receiving layer.

The amount of cross-linking agent coated is preferably within the range of 0.01 to 1.0 g/m², and more preferably 0.05 to 0.5 g/m². If the amount is less than 0.01 g/m², effect of preventing the generation of cracks is reduced, and if the amount exceeds 1.0 g/m², on the other hand, there is a danger that bending or breaking of the ink receiving layer may be caused due to strong constriction generated during drying and that the ink absorption property thereof may be lowered.

According to the present invention, in order to improve the high temperature and humidity resistance, it is possible to include aluminum compounds, such as basic aluminum chloride, basic aluminum sulfate, and basic aluminum fatty acids; and zirconyl compounds, such as zirconyl chloride, basic zirconyl chloride, zirconyl nitrate, and zirconyl fatty acids. Specific examples of the fatty acids in the basic aluminum fatty acids, zirconyl fatty acids include, formic acid, acetic acid, propionic acid, butanic acid, glycolic acid, 3-hydorxy propionic acid, 4-hydroxy butanic acid, glycine, β-alanine, 4-amino butanic acid, oxalic acid, malonic acid, succinic acid, glutaric acid, azipic acid and so forth in the ink receiving layer. Among them, acetic acid is particularly preferable.

Also, according to the present invention, it is possible to use various known compounds which are used to improve preservability, such as light resistance and gas resistance. Examples of such compounds include phenol type antioxidants, hindered amine photo stabilizers, benzotriazole ultraviolet ray absorbents, sulfur compounds, water soluble metallic salt and so forth.

Moreover, according to the present invention, it is possible to use oxoacid salt of phosphorus as a coating stabilizer. Specific examples thereof include alkali metal salt, alkaline earth metal salt, ammonium salt, zincate, etc., of phorsphoric acid, phosphorous acid, hypophosphorous acid, metaphosphoric acid, metaphosphorous acid, pyrophosphoric acid, pyrophosphorous acid, polyphosphoric acid, and so forth.

Among these, hypophosphite is preferable from the viewpoint of its excellent effect of coating stability.

Specific examples of the hypophosphite include sodium hypophosphite, potassium hypophosphite, calcium hypophosphite, magnesium hypophosphite, barium hypophosphite, ammonium hypophosphite, zinc hypophosphite and so forth. Among these, sodium hypophosphite is particularly preferable due to its highest effect of coating stability.

It is also possible to add various known dispersing agents, thickeners, flowability modifiers, antifoamers, foam inhibitors, release agents, foaming agents, penetrants, colorants, pigments, fluorescent brighteners, antiseptics, antimordant and so forth in the ink receiving layer.

The ink receiving layer may be formed by applying a solution for ink receiving layer including the above-mentioned various components onto at least one surface of a supporting medium, and drying it.

The amount of the solution for the ink receiving layer applied is preferably in the range of 2 to 50 g/m², and more preferably in the range of 3 to 30 g/m², in dry mass for the case where the ink receiving layer is not formed by the above-mentioned inside ink receiving layer and outside ink receiving layer. If the applied amount is within the above-mentioned range, excellent quality of recorded image and coating strength may be obtained.

The solution for the ink receiving layer may be coated using a bar coater, a blade coater, an air knife coater, a gravure coater, a die coater, a curtain coater, and so forth.

Also, for the case where the ink receiving layer is formed by, after forming at least one inside ink receiving layer, applying an aqueous coating solution including the polymer (A) onto the inside ink receiving layer, and applying a solution for ink receiving layer thereon to form an outside ink receiving layer as explained above, the amount of the inside ink receiving layer applied is preferably 5 to 50 g/m², and more preferably 10 to 30 g/m², in dry mass. Also, the amount of the outside ink receiving layer applied is preferably 2 to 50 g/m², and more preferably 3 to 30 g/m², in dry mass.

According to the present invention, for the case where the ink receiving layer is formed by a plurality of layers of inside ink receiving layer and outside ink receiving layer as explained above, the polymer (A) may be included in at least one ink receiving layer. However, it is preferable that the polymer (A) be included in an outside ink receiving layer which is located at or close to the top of the plurality of layers. In this manner, it becomes possible to improve the print density and preservability.

Also, ink jet recording sheet having a higher degree of surface glossiness may be obtained by, after applying a solution for ink receiving layer, subjecting a coated layer to a cast process while the layer is in a wet state so the ink receiving layer is directly cast.

Methods for the cast process include wet process, gelling process and rewetting process. In the wet process, a coated layer is pressure welded to a heated specular surface drum while the coated layer is in a wet state to obtain a strong calender finish. In the gelling process, a coated layer is contacted a gelling agent vessel while the coated layer is in a wet state, and the coated layer turned into a gel state is press welded to a heated drum surface to obtain a strong calender finish. In the rewetting process, after a coated layer in a wet state is once dried, the dried coated layer is contacted a wetting solution again, and then the layer is press welded to a heated drum surface to obtain a strong calender finish.

When the ink receiving layer is subjected to a cast process, it is preferable that a parting agent be included in the ink receiving surface. As a parting agent, various parting agents which are generally known in the field of coated paper may be utilized.

Also, after forming the ink receiving layer, in order to impart glossiness, etc., it is possible to make smooth the surface thereof by passing between roll nips while applying pressure to it using, for example, a super calender, gloss calender, soft calender, and so forth.

Other Structure Gloss Layer

According to the present invention, it is possible to provide a gloss layer, which has been subjected to a cast process, on the above-mentioned ink receiving layer. In this manner, ink jet recording sheet having higher surface glossiness may be obtained.

The glossy layer may include pigments and/or resins.

It is preferable to make the glossy layer porous or liquid permeable within a range not interfering with the glossiness thereof so that the ink may be passed through or be absorbed by the glossy layer quickly.

The pigment used in the glossy layer may be the same as those of inorganic fine particle used in the ink receiving layer. However, from the viewpoints of glossiness, transparency, and ink absorption, colloidal silica, amorphous silica, alumina, alminosilicate, zeolite, synthesized smectite, etc., are preferable.

It is preferable that the amount of the pigments contained in the glossy layer be in the range of 10 to 90% by mass.

The average particle size of the pigment (the size of aggregated particle for aggregated particles) is preferably within the range of 0.001 to 1 μm, and more preferably 0.005 to 0.5 μm. If the particle size is within this range, excellent ink absorptivity, glossiness, and print density may be obtained.

Examples of resins used in the glossy layer include water soluble binder (for example, polyvinyl alcohols, such as polyvinyl alcohol, cation denatured polyvinyl alcohol and silyl denatured polyvinyl alcohol; casein, soy bean protein synthesized proteins, starch, and cellulose derivatives, such as carboxy methyl cellulose and methyl cellulose); conjugated diene polymer latex, such as styrene-butadiene copolymer and methylmethacrylate-butadiene copolymer; vinyl copolymer latex, such as styrene-vinyl acetate copolymer; various resins (adhesives) generally known and used in the field of coated paper, such as an aqueous dispersion resin, aqueous acryl resin, aqueous polyurethane resin, and aqueous polyester resin. These may be used solely or in a mixture.

Note that when a glossy layer is formed mainly by a resin, it is preferable that the resin include, as a main component, polymer or copolymer (hereinafter abbreviated as polymer) formed by polymerizing monomer having ethylenically unsaturated bonding (hereinafter referred to as an ethylenic monomer). Also, it is possible to use substituted derivatives of these polymers.

Moreover, it is possible to polymerize the above-mentioned ethylenic polymer in the presence of colloidal silica to make it a complex bonded by Si—O—R (where R is a polymer component) bonding, or to introduce a functional group, such as SiOH group, which reacts with colloidal silica, into the above-mentioned polymer so that the polymer may be reacted with colloidal silica to form a complex. These complexes may also be suitably used in the present invention. When such a complex is used, the resulting ink receiving layer tends to have excellent glossiness and ink absorption.

Since the glossy layer is subjected to a cast process, the glass transition point of a resin which forms the glossy layer is preferably 40° C. or more, and more preferably within the range between 50 and 100° C. If the glass transition point is low, there is a danger that the ink absorption rate is reduced since the formation of the layer is too advanced during a drying process and the porosity of the surface is reduced.

It is also preferable that a parting agent be included in the glossy layer. Examples of the parting agents include various parting agents which are known and generally used in the field of coated paper.

Moreover, it is possible to add to the glossy layer a cationic compound to enhance the print concentration and water resistance, and various adjuvants in order to improve the light resistance and gas resistance.

The glossy layer is formed by applying a solution for glossy layer including the above-mentioned various components onto an ink receiving layer to form a coated layer, subjecting the coated layer to a cast process, and drying it.

The amount of a solution for glossy layer applied is preferably 0.1 to 30 g/m², more preferably 0.2 to 10 g/m², in dry mass. If the applied amount is within this range, glossiness, ink drying property, and recording density become excellent.

The coating and cast process of the solution for glossy layer may be carried out using the same methods as described for the above-mentioned ink receiving layer.

The drying temperature for the glossy layer is also important. If the drying temperature is too high, the formation of the layer is too advanced and the porosity of the surface is reduced. As a result, the ink absorption rate decreases. If the drying temperature is too low, on the other hand, there is a tendency that the glossiness as well as productivity is reduced. The drying temperature is preferably in the range between 50 and 150° C., and more preferably between 70 and 120° C.

Also, according to the present invention, various techniques known in the field of producing ink jet recording sheet may be utilized. Accordingly, it is possible to provide an intermediate layer between the supporting medium and the ink receiving layer, to dispose a protective layer at the back surface, i.e., the surface on which the ink receiving layer is not formed, of the supporting medium, to make the back surface thereof sticky, and so forth.

Liquid ink used for forming a recording image on ink jet recording sheet according to the present invention may be a recording liquid including coloring agents, liquid medium, and other arbitrary selected additives. Commercially available arbitrary liquid ink for ink jet recording may also be used.

Examples of the coloring agents include various water soluble dye, such as direct dye, acidic dye, reactive dye, etc., and carbon black and organic pigments whose particle size is adjusted to be about 100 nm and is surface treated by a resin, surfactant, and so forth.

Also, as a liquid medium, water may be used solely or in combination with water soluble organic solvent. Examples of the water soluble organic solvent include monovalent alcohol, such as ethylalcohol and isopropyl alcohol; polyvalent alcohol, such as ethylene glycol, diethylene glycol, polyethylene glycol and glycerin; and a lower alkyl ether of polyalcohol, such as triethylene glycol monomethyl ether and triethylene glycol monoethyl ether.

Examples of the additives include a pH controlling agent, sequestering agent, antimordant, viscosity controlling agent, surface tension controlling agent, surfactant, rust inhibitor, and so forth.

On the other hand, the method for producing ink jet recording sheet according to the present invention is a method in which an ink receiving layer including at least two layers containing inorganic fine particle and binder, is formed on a supporting medium, and the method may be characterized by, after forming at least one layer of inside ink receiving layer which includes inorganic fine particles and binder (an inside ink receiving layer forming process), an aqueous coating layer is formed on the inside ink receiving layer by applying an aqueous solution including an cationic compound (an aqueous coating layer forming process), and at least one layer of outside ink receiving layer which includes inorganic fine particles and binder is formed on the aqueous coating layer (an outside ink receiving layer forming process).

Hereinafter, each of the above-mentioned processes will be explained in detail.

“Inside Ink Receiving Layer Forming Process”

In this process, at least one layer of inside ink receiving layer, which includes inorganic fine particles and binder, is formed on a supporting medium.

Supporting Medium

As a supporting medium, the above-mentioned conventionally known supporting medium for ink jet recording paper may be properly used. For example, it is preferable to use a water resistant supporting medium having a thickness of 100 to 400 μm in order to obtain a higher density and clear image.

Inside Ink Receiving Layer Inorganic Fine Particle

As a material for the inorganic fine particle contained in the ink receiving layer, the above-mentioned various inorganic fine particles known in the field of general coated paper are properly used. It is preferable to use amorphous silica, alminosilicate, aluminum, and almina hydrate from the viewpoint of ink absorption, and among them, use of silica is particularly preferable. Also, the same inorganic fine particles which are used for an outside ink receiving layer described later may also be utilized for the inside ink receiving layer.

Binder

Examples of the binder which may be contained in the inside ink receiving layer include the above-mentioned starch derivatives, cellulose derivatives, proteins, polyvinyl alcohols, aqueous adhesives, and organic solvent soluble resin, and these may be used singularly or in a mixture of two or more. Among these binders, the above-mentioned polyvinyl alcohols, in particular, completely (partially) saponificated polyvinyl alcohol, cation denatured polyvinyl alcohol, and silicon denatured polyvinyl alcohol are preferable.

Cationic Compound

If necessary, various known cationic compounds which will be described later may also be utilized.

Other Components

As described above, according to the present invention, it is preferable that a cross-linking agent be used together with the above-mentioned binder. In this manner, generation of cracks may be reduced, and the ink absorptivity, glossiness, image quality, and so forth may further be improved.

Formation of Inside Ink Receiving Layer

The inside ink receiving layer may be formed by applying a coating solution for inside ink receiving layer which includes the above-mentioned various components, onto at least one surface of a supporting medium, and drying it.

The amount of the coating solution of inside ink receiving layer applied is preferably 2 to 50 g/m², more preferably 3 to 30 g/m², in dry mass. If the applied amount is within the above-mentioned range, excellent quality of recorded image and coating strength may be obtained.

The coating solution for the ink receiving layer may be coated using a bar coater, a blade coater, an air knife coater, a gravure coater, a die coater, a curtain coater, and so forth.

According to the present invention, the inside ink receiving layer may be of one layer or two or more of plurality of layers.

“Aqueous Coating Layer Forming Process”

Then, aqueous solution including a cationic compound is applied onto the inside ink receiving layer formed as described above so that an aqueous coating layer is formed thereon.

Cationic Compound

As the cationic compound used in the present invention, various cationic compounds known and used in the field of ink jet recording sheet, such as cationic polymer, water soluble aluminum compounds, water soluble zirconyl compounds, and water soluble titanium compounds, are properly employed. In particular, from the viewpoint of water resistance, cationic polymer, water soluble aluminum compounds, and water soluble zirconyl compounds are preferably used, and among these, cationic polymer is particularly preferable.

These cationic compounds may be used singularly or in a mixture.

Examples of the cationic polymer include a primary amine type cationic polymer having, as a structural unit, a primary amine salt, such as monoallylamine salt, vinylamine salt, N-vinylacrylamidine salt, dicyandiamide.formalin polycondensation products, and dicyandiamide.polyethyleneamine polycondensation products; a secondary amine type cationic polymer having, as a structural unit, a secondary amine salt, such as diallylamine salt and ethyleneimine salt; a tertiary amine type cationic polymer having, as a structural unit, a tertiary amine salt, such as diallylmethylamine salt; a quaternary ammonium type cationic polymer having, as a structural unit, a quaternary ammonim salt, such as diallyldimethylammoniumchloride, (meth)acryloyloxyethyltrimethylammoniumchloride, (meth)acrylamidepropyltrimethylammoniumchloride, dimethyl amine.epichlorohydrin polycondensation products.

Examples of the water soluble aluminum compounds include basic aluminum chloride, basic aluminum sulfate, and basic aluminum fatty acid.

Examples of the water soluble zirconyl compounds include zirconyl chloride, basic zirconyl chloride, zirconyl nitrite, zirconyl fatty acid, and so forth.

Specific examples of the fatty acid in the basic aluminum fatty acid, zirconyl fatty acid, etc., include formic acid, acetic acid, propionic acid, butanic acid, glycolic acid, 3-hydorxy propionic acid, 4-hydroxy butanic acid, glycine, 1-alanine, 4-amino butanic acid, oxalic acid, malonic acid, succinic acid, glutaric acid, azipic acid and so forth. Among these, acetic acid is particularly preferable.

The coating amount of the cationic compound is preferably 0.01 to 10 g/m², and more preferably 0.05 to 5 g/m². If the coating amount is within this range, higher image quality and image preservability may be obtained.

According to the present invention, as mentioned above, the polymer (A) including at least one structural unit (a1) expressed by the above general formula (1) or (2) and at least one structural unit (a2) expressed by the above general formula (3), (4), (5) or (6) is preferably used. By using an aqueous solution including the polymer (A), the problem of generation of cracks on the ink receiving layer is significantly reduced. Also, glossiness and ink absorptivity of the ink receiving layer are improved. Moreover, quality of image formed on the ink receiving layer and the long-term preservability thereof are enhanced.

As mentioned above, in the general formula (1) and (2), m and n represent, independent of each other, an integer of 0 to 4, preferably 1.

Also, as mentioned above, in the general formula (3) to (6), R¹ to R⁸ represent, independent of each other, a hydrogen atom or an alkyl group having a number of carbon atoms of 1 to 4. From the viewpoint of availability and resistance to crack generation, it is preferable that all of R¹ to R⁸ represent a hydrogen atom.

In the general formula (2), (4) and (6), X, Y and Z each represents, independent to each other, an acid residue, and the acid thereof (HX, HY, HZ, HW) may be inorganic acids or organic acids.

Specific examples of the structural unit (a1) expressed by the general formula (1) or (2) include a structural unit which possesses a primary amine having a vinyl alkyl group, such as vinyl amine, allyl amine, vinylethyl amine, and vinyl butyl amine or an acid salt thereof as a monomer.

Specific examples of the structural unit (a2) expressed by the general formula (3), (4), (5) or (6) include a structural unit which possesses a secondary amine having two vinyl alkyl groups, such as diallylamine, di(2-methyl allyl)amine and di(2-ethylallyl)amine or an acid salt thereof as a monomer.

The molar ratio of the structural unit (a1) to the structural unit (a2) in the polymer (A) is preferably in the range between 0.1:1 to 10:1, and more preferably 0.5:1 to 5:1. If the molar ratio is within this range, it becomes possible to improve the ink receiving layer so that an image of high quality and an excellent long-term preservability, especially, are obtained.

The polymer (A) may have a structural unit (a3) other than the above-mentioned structural unit (1) to (6).

As the structural unit (a3), a structural unit having a known ethylenically unsaturated compound as a monomer, which is capable of copolymerizing the monomer of the structural unit (1) to (6), may be used, and specific examples of the structural unit (a3) are explained above.

Among these, a structural unit in which acryl amide is a monomer, i.e., a structural unit expressed by the following formula (7), is preferable since the generation of cracks on the ink receiving layer is reduced, and high glossiness and preservability, such as light resistance and ozone resistance may further be improved.

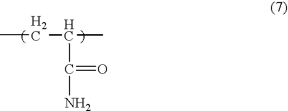

In order to exert the effect of the present invention in a more efficient manner, it is preferable that the total amount of the structural unit (a1) and the structural unit (a2) in the polymer (A) is 50% by mass or more with respect to the weight of the polymer (A).

The molecular weight of the polymer (A) used in the present invention is preferably within the range between 5,000 to 500,000, and more preferably between 10,000 to 200,000. If the molecular weight thereof is within this range, image quality, preservability, such as light resistance and high temperature and humidity resistance, and ink absorption become excellent, and the generation of cracks is reduced.

Cross-Linking Agent

According to the present invention, it is preferable to add a cross-linking agent into an aqueous solution containing the above-mentioned cationic compound in order to inhibit the generation of cracks.

Specific examples of the cross-linking agent include boron compounds, such as boric acid, borax and borate; glyoxzal, melamine.formaldehyde, gultaraldehyde, methylol urea, polyisocyanate compounds, epoxy compounds, aziridine compounds, carbodiimido compounds, dihidrazide compounds, aluminum compounds, zirconyl compounds, and so forth. Among these, boron compounds are preferable, and borax is particularly preferable.

According to the present invention, it is preferable to apply an aqueous solution including borax with the polymer (A). By applying a mixed solution of borax and the polymer (A), it becomes possible to particularly improve the high temperature and humidity resistance, and the crack generation inhibitory effect may also be improved.

Also, it is preferable to adjust pH of the mixed solution within the range of 7.0 to 10.0, more preferably 7.5 to 9.0 using alkali, such as sodium hydroxide, prior to use since it is effective for preventing the generation of cracks.

For the case where a cross-linking agent is added, the amount of the cross-linking agent applied is preferably 0.01 to 3.0 g/m², more preferably 0.05 to 2.0 g/m². If the amount is less than 0.01 g/m², the effect of preventing the generation of cracks is reduced, and if it exceeds 3.0 g/m², on the other hand, there is a danger that bending or breaking of the ink receiving layer may be caused due to strong constriction generated during drying and that the ink absorption property thereof may be lowered.

Also, the mass ratio of the cross-linking agent to the polymer (A) is preferably within the range between 20:1 to 1:20, and more preferably 10:1 to 1:10. If the mass ratio is within this range, ink jet recording sheet which are excellent in time-lapse feathering resistance and ink absorption property may be obtained.

Formation of Aqueous Coating Layer

The aqueous coating solution of the above-mentioned cationic compound may be applied using a bar coater, a blade coater, a rod blade coater, an air knife coater, a gravure coater, a die coater, a curtain coater, and so forth. Use of a bar coater or a rod blade coater is particularly preferable.

“Outside Ink Receiving Layer Formation Process”

Then, at least one layer of an outside ink receiving layer including inorganic fine particle and binder is formed on the aqueous coating layer.

The outside ink receiving layer is formed while the aqueous coating layer is in a wet state.

Outside Ink Receiving Layer Inorganic Fine Particle

As materials which may be included in the outside ink receiving layer, similar to the materials used for the inside ink receiving layer, various inorganic fine particle known and used in the field of a general coated paper may be suitably used.

As explained above, according to the present invention, the average primary particle size of the inorganic fine particle contained in the outside ink receiving layer is preferably 30 nm or less, and more preferably between 3 to 15 nm.

For the case where the inorganic fine particle is formed by aggregated particles (secondary particle) in which primary particles are aggregated, although the secondary particle size is not particularly limited, it is preferably 0.05 to 1.0 μm, and more preferably 0.05 to 0.5 g m.

Also, as mentioned above, the specific surface area measured by the BET method of the inorganic fine particle is preferably 100 m²/g or more, and more preferably in the range between 200 to 400 m²/g.

The amount of the inorganic fine particle used in the ink receiving layer is preferably about 20 to 95% by mass, more preferably about 30 to 90% by mass, with respect to the solid components of the ink receiving layer as mentioned above.

According to the present invention, as mentioned above, silica, especially wet process fine silica is preferably used as the inorganic fine particle.

The outside ink receiving layer may be of one layer or plural layers. If the outside ink receiving layer is formed only by a layer containing the silica-cationic compound aggregated fine particle, a superb coloring property, print concentration, glossiness, and transparency may be obtained. Of course, it is possible to provide an upper layer including the silica-cationic compound aggregated fine particle, and another lower ink receiving layer below the upper layer. In order to maintain the glossiness and shine after printing, it is preferable that the coated amount of the layer having silica colloid particle as a main component be adjusted to 50 to 100% with respect to the entire outside ink receiving layer. Although a satisfactory glossiness may be obtained even if the coated amount is less than 50%, glossiness and shine of a photographic level may be obtained if it is adjusted to be 50 to 100%.

Binder

Kind and amount of binder used in the outside ink receiving layer may be the same as those used in the inside ink receiving layer.

According to the present invention, for the case where the silica-cationic compound aggregated fine particle is used as the inorganic fine particle, PVA is most effective as the binder as mentioned above. Particularly, PVA having a polymerization degree of 2,000 or more is preferably used, and PVA having a saponification degree of 95% or more is preferable to obtain water resistance.

As mentioned above, although the solid component mass ratio of the silica-cationic compound aggregated fine particle to the binder is not particularly limited, it is adjusted to be 100/5 to 100/100, and more preferably 100/10 to 100/60.

Cationic Compound

For the outside ink receiving layer, various known cationic polymer described in the section of the aqueous coating layer may also be used, if necessary.

Other Components

According to the present invention, it is preferable to use the above-mentioned binder together with the above-mentioned cross-linking agent. In this manner, it becomes possible to reduce the generation of cracks and to improve the ink absorptivity, glossiness, image quality, and so forth.

A cross-linking agent may be included in a coating solution for forming the ink receiving layer, or a solution including a cross-linking agent may be applied before or after coating the ink receiving layer.

The amount of cross-linking agent coated is preferably within the range of 0.01 to 1.0 g/m², and more preferably 0.05 to 0.5 g/m². If the amount is less than 0.01 g/m², effect of preventing the generation of cracks is reduced, and if the amount exceeds 1.0 g/m², on the other hand, there is a danger that bending or breaking of the ink receiving layer may be caused due to strong constriction generated during drying and that the ink absorption property thereof may be lowered.

According to the present invention, in order to improve the high temperature and humidity resistance, it is possible to include the above-mentioned aluminum compounds and zirconyl compounds.

Also, according to the present invention, it is possible to use various known compounds which are used to improve preservability, such as light resistance and gas resistance. Examples of such compounds include phenol type antioxidants, hindered amine photo stabilizers, benzotriazole ultraviolet ray absorbents, sulfur compounds, water soluble metallic salt and so forth.

It is also possible to add various known dispersing agents, thickeners, flowability modifiers, antifoamers, foam inhibitors, release agents, foaming agents, penetrants, colorants, pigments, fluorescent brighteners, antiseptics, antimordant and so forth in the ink receiving layer.

Formation of Outside Ink Receiving Layer

The outside ink receiving layer may be formed by applying a coating solution for outside ink receiving layer which includes the above-mentioned various components, onto the aqueous coating layer which is formed in the manner described above, and drying it.

The amount of the coating solution of outside ink receiving layer applied is preferably 2 to 50 g/m², more preferably 3 to 30 g/m², in dry mass. If the applied amount is within the above-mentioned range, excellent quality of recorded image and coating strength may be obtained. If the applied amount is too small, it is difficult to obtain uniform thickness, and if the applied amount is too large, on the other hand, the effect thereof exceeds maximum and cracks tends to be easily generated. For example, in order to obtain high coating amount of 15 g/m² or more, methods increasing viscosity and concentration of a coating solution may be utilized and the coating process may be repeated two times or more.

The coating solution for the outside ink receiving layer may be applied using a bar coater, a blade coater, an air knife coater, a gravure coater, a die coater, a curtain coater, and so forth.

According to the present invention, as mentioned above, the outside ink receiving layer may be of one layer or two or more of plurality of layers.

Also, ink jet recording sheet having higher surface glossiness may be obtained by, after the coating solution for the outside ink receiving layer is applied, subjecting the outside ink receiving layer to a direct casting process while the coated layer is still in a wet state.

Methods of the casting process include the above-mentioned wetting process, gelling process, and rewetting process.

For the case where the outside ink receiving layer is subjected to a cast process, it is preferable that a parting agent be included in the outside ink receiving layer. According to the present invention, various parting agents generally known and used in the field of coated paper may be employed.

Also, after forming the outside ink receiving layer, etc., it is possible to make smooth the surface thereof by passing between roll nips while applying pressure to it using, for example, a super calender, gloss calender, soft calender, and so forth to impart glossiness.

Other Structure

According to the present invention, it is possible to provide a gloss layer, which has been subjected to a cast process, on the above-mentioned outside ink receiving layer. In this manner, ink jet recording sheet having higher surface glossiness may be obtained.

The glossy layer may include pigments and/or resins.

It is preferable to make the glossy layer porous or liquid permeable within a range not interfering with the glossiness thereof so that the ink may be passed through or be absorbed by the glossy layer quickly.

The pigment used in the glossy layer may be the same as those of inorganic fine particle used in the outside ink receiving layer. However, from the viewpoints of glossiness, transparency, and ink absorption, colloidal silica, amorphous silica, alumina, alminosilicate, zeolite, synthesized smectite, etc., are preferable.

It is preferable that the amount of the pigments contained in the glossy layer be in the range of 10 to 90% by mass.

The average particle size of the pigment (the size of aggregated particle for aggregated particles) is preferably within the range of 0.001 to 1 μm, and more preferably 0.005 to 0.5 μm. If the particle size is within this range, excellent ink absorptivity, glossiness, and print density may be obtained.

Examples of resins used in the glossy layer include water soluble binder (for example, polyvinyl alcohols and cellulose derivatives); conjugated diene polymer latex, such as styrene-butadiene copolymer and methylmethacrylate-butadiene copolymer; vinyl copolymer latex, such as styrene-vinyl acetate copolymer; various resins (adhesives) generally known and used in the field of coated paper, such as an aqueous dispersion resin, aqueous acryl resin, aqueous polyurethane resin, and aqueous polyester resin. These may be used solely or in a mixture.

It is preferable that a parting agent be included in the glossy layer. As a parting agent, various parting agents generally known and used in the field of coated paper may be used.

Also, it is possible to add to the glossy layer a cationic compound to enhance the print concentration and water resistance, and various adjuvants in order to improve the light resistance and gas resistance.

The glossy layer is formed by applying a solution for glossy layer including the above-mentioned various components onto the outside ink receiving layer to form a coated layer, subjecting the coated layer to a cast process, and drying it.

The amount of a solution for glossy layer applied is preferably 0.1 to 30 g/m², more preferably 0.2 to 10 g/m², in dry mass. If the applied amount is within this range, glossiness, ink drying property, and recording density become excellent.

The coating and cast process of the solution for glossy layer may be carried out using the same methods as described for the above-mentioned ink receiving layer.

The drying temperature for the glossy layer is also important. If the drying temperature is too high, the formation of layer is too advanced and the porosity of the surface is reduced. As a result, the ink absorption rate decreases. If the drying temperature is too low, on the other hand, there is a tendency that the glossiness as well as productivity is reduced. The drying temperature is preferably within the range between 50 and 150° C., and more preferably between 70 and 120° C.

Also, according to the present invention, various techniques known in the field of producing ink jet recording sheet may be utilized. Accordingly, it is possible to provide an intermediate layer between the supporting medium and the ink receiving layer, to dispose a protective layer at the back surface, i.e., the surface on which the ink receiving layer is not formed, of the supporting medium, to make the back surface thereof sticky, and so forth.

Liquid ink used for forming a recording image on ink jet recording sheet according to the present invention may be a recording liquid including coloring agents, liquid medium, and other arbitrary selected additives. Commercially available arbitrary liquid ink for ink jet recording may also be used.

Examples of the coloring agents include various water soluble dyes, such as direct dye, acidic dye, reactive dye, etc., and carbon black and organic pigments whose particle size is adjusted to be about 100 nm and is surface treated by a resin, surfactant, and so forth.

Also, as a liquid medium, water may be used solely or in combination with water soluble organic solvent. Examples of the water soluble organic solvent include monovalent alcohol, such as ethylalcohol and isopropyl alcohol; polyvalent alcohol, such as ethylene glycol, diethylene glycol, polyethylene glycol and glycerin; and a lower alkyl ether of polyalcohol, such as triethylene glycol monomethyl ether and triethylene glycol monoethyl ether.

Examples of the additives include a pH controlling agent, sequestering agent, antimordant, viscosity controlling agent, surface tension controlling agent, surfactant, rust inhibitor, and so forth.

### EXAMPLES

Hereinafter, the present invention will be explained in detail with reference to Examples. However, it is apparent that the present invention is not limited to these examples. Also, “parts” and “%” used in the examples indicate “parts by mass” and “% by mass” unless otherwise so indicated.

### Example 1

(Preparation of Coating Solution A for Ink Receiving Layer)

Vapor phase silica (100 parts, trade name: Aerosil 300, a product of Aerosil Co., average particle size of primary particle of 7 nm, BET specific surface area of 300 m²/g), 40% aqueous solution of allylamine hydrochloride.diallylamine hydrochloride copolymer (38 parts, molar ratio of allylamine hydrochloride to diallylamine hydrochloride of 4:1, molecular weight of about 20,000), and ion exchanged water (862 parts) were mixed and dispersed using an agitating device, and the mixture was treated using a wet type nanomizer. Then, 5% aqueous solution of polyvinyl alcohol (360 parts, trade name: PVA-145, a product of Kuraray Co., Ltd., saponification degree of 99%, average polymerization degree of 4,500) and a small amount of antifoaming agent, dispersing agent and water were added. As a result, a coating solution A for ink receiving layer having a solid component concentration of 8% was obtained.

(Preparation of Coating Solution B for Ink Receiving Layer)

To a 20% dispersion of wet process synthesized amorphous silica (500 parts, trade name: Sylojet 703A, a product of Grace Davison Co. Ltd.), 5% aqueous solution of polyvinyl alcohol (400 parts, trade name: PVA-145, a product of Kuraray Co., Ltd.), and a small amount of antifoaming agent, dispersing agent and water were added. As a result, a coating solution B for ink receiving layer having a solid component concentration of 15% was obtained.

(Preparation of Ink Jet Recording Sheet)

The coating solution B for ink receiving layer was applied onto a paper supporting medium in which both surfaces of 180 g/m² base paper were coated by polyethylene resin (thickness of 240% m, and the polyethylene resin included 15% by mass of anatase titanium dioxide) using a wired bar so that the solid component contained in the coating solution B became 20 g/m², and this was dried to prepare an ink receiving layer B. Then, 0.5% borax aqueous coating solution was applied so as to be 20 g/m², and the coating solution A for ink receiving layer was applied thereon using a wired bar and dried so that the solid component contained in the coating solution A became 7 g/m² to obtain ink jet recording sheet.

### Examples 2-7

Ink jet recording sheet was prepared in the same manner as in Example 1 except that the following compound was used instead of allylamine hydrochloride.diallylamine hydrochloride copolymer (molar ratio of 4:1, and molecular weight of about 20,000):
In Example 2: allylamine hydrochloride.diallylamine hydrochloride copolymer (molar ratio of 2:1, and molecular weight of about 100,000);
In Example 3: allylamine hydrochloride.diallylamine hydrochloride copolymer (molar ratio of 1:1, and molecular weight of about 70,000);
In Example 4: allylamine hydrochloride.diallylamine hydrochloride.acrylamide copolymer (molar ratio of 1:1:1, and molecular weight of about 100,000);
In Example 5: allylamine methanesulfonate.diallylamine methanesulfonate copolymer (molar ratio of 1:1, and molecular weight of about 50,000);
In Example 6: allylamine hydrochloride.diallylamine hydrochloride copolymer (molar ratio of 1:1, and molecular weight of about 300,000); and
In Example 7: vinylamine hydrochloride.diallylamine hydrochloride copolymer (molar ratio of 1:1, and molecular weight of about 50,000).

### Example 8

Ink jet recording sheet was prepared in the same manner as in Example 1 except that 40% aqueous solution of allylamine hydrochloride.diallylamine hydrochloride copolymer (20 parts, molar ratio of 4:1, and molecular weight of about 20,000) and 30% aqueous solution of N-vinyl acrylamidine hydrochloride.acrylamide copolymer (27 parts, molar ratio of 2:1, and molecular weight of about 20,000) were used instead of 40% aqueous solution of allylamine hydrochloride.diallylamine hydrochloride copolymer (38 parts, molar ratio of 4:1, and molecular weight of about 20,000).

### Examples 9-10

Ink jet recording sheet was prepared in the same manner as in Example 3 except that the following compounds were further added:
In Example 9: 100 parts of basic aluminum acetate aqueous solution (concentration of 5% converted to Al₂O₃); and
In Example 10, 15 parts of zirconyl acetate aqueous solution (concentration of 30% converted to ZrO₂).

### Example 11

(Preparation of Silica Fine Particle Dispersion)

Distilled water was added to silicate soda solution having a SiO₂ concentration of 30% by mass and SiO₂/Na₂O (molar ratio) of 3.1 (a product of Tokuyama Corporation) to prepare diluted silicate soda aqueous solution having SiO₂ concentration of 4.0% by mass, and the aqueous solution was passed through a column filled with a hydrogen cation exchange resin (“Diaion SK-1BH”, a product of Mitsubishi Chemical Corporation) to obtain an active silicate solution. Distilled water (500 g) was introduced to a 5 liter reaction vessel made of glass, which was provided with a reflux, stirrer and thermometer and heated to 100° C. While maintaining the temperature of 100° C., 450 g of the prepared active silicate solution was added at a rate of 1.5 g/min to prepare a seed solution. The average primary particle size of seed particle aggregate in the seed solution was 184 nm.

Then, after 0.9 g of 28% ammonia aqueous solution was added to stabilize the seed solution, 550 g of the prepared active silicate solution was added to the mixture at a rate of 1.5 g/min while maintaining the temperature of 100° C. After the addition was completed, the mixture was refluxed for 9 hours at 100° C. to concentrate the mixture, and a silica fine particle dispersion of 10% by mass was obtained. The average primary particle size, the average secondary particle size, the specific surface area, and the pore volume of the silica fine particle were 11 nm, 130 nm, 257 m²/g, and 1.01 ml/g, respectively.

(Preparation of Coating Solution C for Ink Receiving Layer)

To 1,000 parts of the 10% by mass silica fine particle dispersion obtained as above, 40% aqueous solution of allylamine hydrochloride.diallylamine hydrochloride copolymer (38 parts, molar ratio of allylamine hydrochloride to diallylamine hydrochloride of 1:1, molecular weight of about 70,000) was added. The solution was dispersed using an agitating device, and the mixture was treated using a wet type nanomizer. Then, 5% aqueous solution of polyvinyl alcohol (360 parts, trade name: PVA-145, a product of Kuraray Co., Ltd., saponification degree of 99%, and average polymerization degree of 4,500) and a small amount of antifoaming agent, dispersing agent and water were added. As a result, a coating solution C for ink receiving layer having a solid component concentration of 8% was obtained.

(Preparation of Ink Jet Recording Sheet)

The coating solution B for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B became 20 g/m², and this was dried to prepare an ink receiving layer B. Then, 0.5% borax aqueous coating solution was applied so as to be 20 g/m², and the coating solution C for ink receiving layer was applied thereon using a wired bar and dried so that the solid component contained in the coating solution C became 7 g/m to obtain ink jet recording sheet.

### Example 12

After 1% borax aqueous coating solution 20 g/m² was applied onto a paper supporting medium in which both surfaces of 180 g/m² base paper were coated by polyethylene resin (thickness of 240 μm, and the polyethylene resin included 15% by mass of anatase titanium dioxide), the coating solution A for ink receiving layer was applied thereon using a wired bar and dried so that the solid component contained in the coating solution A became 20 g/m² to obtain ink jet recording sheet.

### Example 13

(Preparation of Coating Solution D for Ink Receiving Layer)

Vapor phase silica (100 parts, trade name: Aerosil 300, a product of Aerosil Co.), 30% aqueous solution of N-vinyl acrylamidine hydrochloride.acrylamide copolymer (50 parts, molar ratio of 2:1, and molecular weight of about 20,000), and ion exchanged water (850 parts) were mixed and dispersed using an agitating device, and the mixture was treated using a wet type nanomizer. Then, 5% aqueous solution of polyvinyl alcohol (360 parts, trade name: PVA-145, a product of Kuraray Co., Ltd., saponification degree of 99%, average polymerization degree of 4,500) and a small amount of antifoaming agent, dispersing agent and water were added. As a result, a coating solution D for ink receiving layer having a solid component concentration of 8% was obtained.

(Preparation of Ink Jet Recording Sheet)

The coating solution B for ink receiving layer was applied onto a paper supporting medium in which both surfaces of 180 g/m base paper were coated by polyethylene resin (thickness of 24011 m, and the polyethylene resin included 15% by mass of anatase titanium dioxide) using a wired bar so that the solid component contained in the coating solution B became 20, and this was dried to prepare an ink receiving layer B. Then, aqueous solution (1:5 mixed solution, concentration of 3%) of borax-allylamine hydrochloride diallylamine hydrochloride copolymer (molar ratio of allylamine hydrochloride to diallylamine hydrochloride of 4:1, and molecular weight of about 20,000) was applied so as to be 20 g/m², and the coating solution D for ink receiving layer was applied thereon using a wired bar and dried so that the solid component contained in the coating solution D became 7 g/m² to obtain ink jet recording sheet.

### Examples 14-18

Ink jet recording sheet was prepared in the same manner as in Example 13 except that the following compound was used instead of allylamine hydrochloride.diallyl amine hydrochloride copolymer (molar ratio of 4:1, and molecular weight of about 20,000):
In Example 14: allylamine hydrochloride.diallylamine hydrochloride copolymer (molar ratio of 1:1, and molecular weight of about 70,000);
In Example 15: allylamine hydrochloride.diallylamine hydrochloride.acrylamide copolymer (molar ratio of 1:1:1, and molecular weight of about 100,000);
In Example 16: allylamine.diallylamine copolymer (molar ratio of 4:1, and molecular weight of about 20,000);
In Example 17: allylamine.diallylamine copolymer (molar ratio of 1:1, and molecular weight of about 50,000); and
In Example 18: allylamine methanesulfonate.diallylamine methanesulfonate copolymer (molar ratio of 1:1, and molecular weight of about 50,000).

### Example 19

(Preparation of Coating Solution E for Ink Receiving Layer)

A coating solution E for ink receiving layer was obtained by mixing wet process amorphous silica (100 parts, trade name: Fine Sill X-30, a product of Tokuyama Corporation), 10% aqueous solution of silicon denatured polyvinyl alcohol (200 parts, trade name: R-1130, a product of Kuraray Co., Ltd., saponification degree of 98.5%, and average polymerization degree of 3,000), and a small amount of antifoaming agent, dispersing agent and water.

(Preparation of Coating Solution F for Ink Receiving Layer)

Vapor phase silica (100 parts, trade name: Aerosil 300, a product of Aerosil Co.), 40% aqueous solution of allylamine hydrochloride.diallylamine hydrochloride copolymer (75 parts, molar ratio of 4:1, and molecular weight of about 20,000), and ion exchanged water (825 parts) were mixed and dispersed using an agitating device, and the mixture was treated using a wet type nanomizer. Then, 10% aqueous solution of polyvinyl alcohol (200 parts, trade name: PVA-117, a product of Kuraray Co., Ltd., saponification degree of 98.5%, and average polymerization degree of 1,700) and a small amount of antifoaming agent, dispersing agent and water were added. As a result, a coating solution F for ink receiving layer having a solid component concentration of 10% was obtained.

(Preparation of Coating Solution G for Glossy Layer)

A coating solution G for glossy layer having a solid component concentration of 5% was obtained by mixing a complex of styrene-2-hexyl acrylate copolymer and colloidal silica (100 parts, glass transition temperature of 75° C., and mass ratio of the copolymer and colloidal silica of 20:8), 5 parts of alkylvinyl ether maleic acid derivative copolymer, 3 parts of stearyl potassium phosphate, 25 parts of polyethylene was, and 5 parts of casein.

(Preparation of Ink Jet Recording Sheet)

The coating solution E for ink receiving layer was applied onto 200 g/m² of woodfree paper using a wired bar so that the solid component contained in the coating solution E became 10 g/m², and this was dried. Then, the coating solution F for ink receiving layer was applied using a wired bar so that the solid component contained in the coating solution F became 5 g/m², and this was dried to prepare an ink receiving layer F. Also, immediately after the coating solution G for glossy layer was applied using a wired bar, it was press welded to a specular surface drum, the surface temperature thereof was 95° C., dried, and separated therefrom to obtain ink jet recording sheet having a glossy layer G. The coated amount of the glossy layer G was 2 g/m² converted to solid component.

### Examples 20-21

Ink jet recording sheet was prepared in the same manner as in Example 19 except that the following compound was used instead of allylamine hydrochloride.diallyl amine hydrochloride copolymer (molar ratio of 4:1, and molecular weight of about 20,000):
In Example 20: allylamine hydrochloride.diallylamine hydrochloride copolymer (molar ratio of 1:1, and molecular weight of about 70,000); and
In Example 21: allylamine hydrochloride.diallylamine hydrochloride.acrylamide copolymer (molar ratio of 1:1:1, and molecular weight of about 100,000).

### Example 22

(Preparation of Coating Solution H for Ink Receiving Layer)

Vapor phase silica (100 parts, trade name: Aerosil 300, a product of Aerosil Co.), 30% aqueous solution of allylamine hydrochloride.diallylamine hydrochloride copolymer (100 parts, molar ratio of 1:1, and molecular weight of about 70,000), and ion exchanged water (800 parts) were mixed and dispersed using an agitating device, and the mixture was treated using a wet type nanomizer. Then, 25% aqueous solution of cationic polyurethane resin (120 parts, trade name: F-8564D, a product of Dai-ichi Kogyo Seiyaku Co., Ltd., Tg of 73° C.), 10 parts of polyethylene was, and a small amount of antifoaming agent, dispersing agent and water were added. As a result, a coating solution H for ink receiving layer having a solid component concentration of 10% was obtained.

(Preparation of Ink Jet Recording Sheet)

The coating solution E for ink receiving layer was applied onto 200 μm² of woodfree paper using a wired bar so that the solid component contained in the coating solution E became 10 g/m², and this was dried to prepare an ink receiving layer F. Then, the coating solution H for ink receiving layer was applied using a wired bar so that the solid component contained in the coating solution H became 5 g/m². Immediately after this, it was press welded to a specular surface drum, the surface temperature thereof was 95° C., dried, and separated therefrom to obtain ink jet recording sheet having an ink receiving layer H.

### Comparative Examples 1-3

Ink jet recording sheet was prepared in the same manner as in Example 1 except that the following compound was used instead of allylamine hydrochloride.diallyl amine hydrochloride copolymer (molar ratio of 4:1, and molecular weight of about 20,000):
In Comparative Example 1: polyallylamine hydrochloride (molecular weight of about 100,000);
In Comparative Example 2: polydiallylamine hydrochloride (molecular weight of about 50,000); and
In Comparative Example 3: polydimethyldiallyl ammonium chloride (molecular weight of about 200,000).

### Comparative Example 4

Ink jet recording sheet was prepared in the same manner as in Example 13 except that 0.5% borax aqueous solution was used instead of aqueous solution (1:5 mixed solution, concentration of 3%) of borax-allylamine hydrochloride diallylamine hydrochloride copolymer (molar ratio of allylamine hydrochloride to diallylamine hydrochloride of 4:1, and molecular weight of about 20,000).

### Comparative Examples 5-7

Ink jet recording sheet was prepared in the same manner as in Example 19 except that the following compound was used instead of allylamine hydrochloride diallylamine hydrochloride copolymer (molar ratio of 4:1, and molecular weight of about 20,000):
In Comparative Example 5: polyallylamine hydrochloride (molecular weight of about 100,000);
In Comparative Example 6: polydiallylamine hydrochloride (molecular weight of about 50,000); and
In Comparative Example 7: polydimethyldiallyl ammonium chloride (molecular weight of about 200,000).
   Evaluation Method 1:

Using ink jet recording sheet obtained by Examples 1 to 18 and Comparative Examples 1 to 4, ISO-400 image (refer to “Highly Fine Color Digital Standard Image Data ISO/JIS-SCID”, p. 13, Image Title: Portrait, issued by Japanese Standards Association) was printed using Epson Ink jet printer PM-950 and solid printing was carried out so that the optical density of composite black became 1.0. The following evaluations were made for the obtained ink jet recording sheet, and the results are shown in the following Table 1.

(Glossiness)

Glossiness of a coated surface of unprinted portion of ink jet recording sheet was visually observed and evaluated.

(Evaluation Standard):
⊚: excellent glossiness;
◯: good glossiness;
Δ: somewhat inferior glossiness; and
X: almost no glossiness.
   (Cracks)

Cracks on a coated surface of unprinted portion of ink jet recording sheet was visually observed and evaluated.

(Evaluation Standard):
⊚: absolutely no cracks;
◯: a few cracks but practically no problem;
Δ: cracks and practically problematic; and
X: numerous cracks.
   (Ink Absorption)

Obtained ISO-400 image was visually observed, and ink absorption of each was evaluated.

(Evaluation Standard):
⊚: absolutely no crushing of image due to ink overflow;
◯: slight crushing of image due to ink overflow but practically no problem;
Δ: crushing of image due to ink overflow and practically problematic; and
X: numerous crushing of image due to ink overflow.
   (Image Quality)

Obtained ISO-400 image was visually evaluated, and image quality of each was evaluated.

(Evaluation Standard):
⊚: excellent image quality;
◯: good image quality and practically no problem;
Δ: inferior image quality and practically problematic; and
X: bad image quality.
   (High Temperature and Humidity Resistance)

Obtained ISO-400 image and solid printing image of composite black were left for 24 hours, and then kept under atmosphere of 40° C. and relative humidity of 90% for 72 hours. After this, the level of high temperature and humidity resistance was visually observed and evaluated.

(Evaluation Standard):
⊚: almost no generation of time-lapse feathering and color fading was observed;
◯: generation of some time-lapse feathering and color fading but practically no problem;
Δ: generation of time-lapse feathering and color fading and practically problematic; and
X: generation of numerous time-lapse feathering and significant color fading.
   (Light Resistance)

Obtained image and solid printing image of composite black were left for 24 hours, and then kept under atmosphere of 63° C. and relative humidity of 40% for 48 hours using a xenon weather meter (“WEL-7S-LHP”, a product of Suga Shikenki Co., Ltd.) After this, the level of light resistance was visually observed and evaluated.

(Evaluation Standard):
⊚: almost no generation of color fading was observed;
◯: generation of some color fading but good in color balance;
Δ: generation of color fading and practically problematic; and
X: generation of significant color fading.

As for the solid printing image of composite black, the optical density before and after the test was measured using Macbeth reflection density measuring device RD-914, and the remaining rate, i.e., optical density after the test/optical density before the test×100 (%), was obtained.

Evaluation Method 2:

Using ink jet recording sheet obtained by Examples 19 to 22 and Comparative Examples 5 to 7, ISO-400 image (refer to “Highly Fine Color Digital Standard Image Data ISO/JIS-SCID”, p. 13, Image Title: Portrait, issued by Japanese Standards Association) was printed using Epson Ink jet printer PM-950 and solid printing was carried out so that the optical density of composite black became 1.0. The above-mentioned evaluations of glossiness, image quality, high heat and humidity resistance, and light resistance were made for the obtained ink jet recording sheet, and the results are shown in the following Table 2.

TABLE 1

| | | | Ink | Image | Temp. & humid. | Light resistance | |
|---|---|---|---|---|---|---|---|
| | Glossiness | Cracks | absorption | quality | resistance | Image | Remaining rate |
| Ex. 1 | ◯ | ◯ | ◯ | ⊚ | ◯ | ⊚ | 81 |
| Ex. 2 | ◯ | ◯ | ◯ | ⊚ | ◯ | ⊚ | 83 |
| Ex. 3 | ◯ | ◯ | ◯ | ⊚ | ◯ | ⊚ | 85 |
| Ex. 4 | ⊚ | ⊚ | ◯ | ⊚ | ◯ | ⊚ | 88 |
| Ex. 5 | ◯ | ◯ | ◯ | ⊚ | ◯ | ⊚ | 84 |
| Ex. 6 | ◯ | ◯ | ◯ | ◯ | ◯ | ◯ | 77 |
| Ex. 7 | ◯ | ◯ | ◯ | ◯ | ◯ | ◯ | 73 |
| Ex. 8 | ◯ | ◯ | ◯ | ⊚ | ◯ | ◯ | 78 |
| Ex. 9 | ◯ | ◯ | ◯ | ⊚ | ⊚ | ⊚ | 83 |
| Ex. 10 | ◯ | ◯ | ◯ | ⊚ | ⊚ | ⊚ | 81 |
| Ex. 11 | ◯ | ◯ | ◯ | ⊚ | ◯ | ⊚ | 84 |
| Ex. 12 | ◯ | ◯ | ◯ | ⊚ | ◯ | ⊚ | 83 |
| Ex. 13 | ⊚ | ⊚ | ⊚ | ⊚ | ◯ | ◯ | 73 |
| Ex. 14 | ⊚ | ⊚ | ⊚ | ⊚ | ◯ | ◯ | 75 |
| Ex. 15 | ⊚ | ⊚ | ⊚ | ⊚ | ◯ | ◯ | 78 |
| Ex. 16 | ⊚ | ⊚ | ⊚ | ⊚ | ◯ | ◯ | 72 |
| Ex. 17 | ⊚ | ⊚ | ⊚ | ⊚ | ◯ | ◯ | 75 |
| Ex. 18 | ⊚ | ◯ | ⊚ | ⊚ | ◯ | ◯ | 76 |
| C. Ex. 1 | Δ | Δ | Δ | Δ | Δ | X | 48 |
| C. Ex. 2 | Δ | Δ | Δ | Δ | X | Δ | 67 |
| C. Ex. 3 | Δ | Δ | Δ | ◯ | X | X | 51 |
| C. Ex. 4 | Δ | Δ | Δ | ◯ | X | X | 56 |

TABLE 2

| | | | | Light resistance | |
|---|---|---|---|---|---|
| | | Image | Temp. & humid. | | Remaining |
| | Glossiness | quality | Resistance | Image | rate |
| Ex. 19 | ◯ | ◯ | ⊚ | ⊚ | 82 |
| Ex. 20 | ◯ | ◯ | ⊚ | ⊚ | 86 |
| Ex. 21 | ◯ | ◯ | ⊚ | ⊚ | 88 |
| Ex. 22 | ◯ | ◯ | ⊚ | ⊚ | 84 |
| C. Ex. 5 | Δ | Δ | Δ | X | 50 |
| C. Ex. 6 | Δ | Δ | X | Δ | 68 |
| C. Ex. 7 | Δ | ◯ | Δ | X | 54 |

As is obvious from the Tables 1 and 2, the ink jet recording sheet of Examples 1 to 22 of the present invention were excellent in that high quality image was formed, almost no time-lapse feathering and color fading were observed even under the high temperature and high humidity environment, almost no color fading occurred even exposed to light for a long period of time, and superb long-term preservability was obtained.

Also, as a supporting medium, the ink jet recording sheet of Examples 1 to 18 in which a water resistant supporting medium was used, was excellent in terms of glossiness, cracks and ink absorptivity, as shown in Table 1. Among these, the ink jet recording sheet of Examples 13 to 17 in which the aqueous solution including borax and cationic polymer was applied, showed particularly excellent results in all of the glossiness, cracks, ink absorptivity, and image quality evaluation.

### Example 23

(Preparation of Coating Solution A′ for Ink Receiving Layer)

Vapor phase silica (100 parts, trade name: Aerosil 300, a product of Aerosil Co., average particle size of primary particle of 7 nm, BET specific surface area of 300 m²/g), 30% aqueous solution of N-vinyl acrylamidine hydrochloride.acrylamide copolymer (50 parts, molar ratio of 2:1, and molecular weight of about 20,000), and ion exchanged water (850 parts) were mixed and dispersed using an agitating device, and the mixture was treated using a wet type nanomizer. Then, 5% aqueous solution of polyvinyl alcohol (360 parts, trade name: PVA-145, a product of Kuraray Co., Ltd., saponification degree of 99%, and average polymerization degree of 4,500) and a small amount of antifoaming agent, dispersing agent and water were added. As a result, a coating solution A′ for ink receiving layer having a solid component concentration of 8% was obtained.

(Preparation of Coating Solution B′ for Ink Receiving Layer)

To a 20% dispersion of wet process synthesized amorphous silica (500 parts, trade name: Sylojet 703A, a product of Grace Davison Co. Ltd.), 5% aqueous solution of polyvinyl alcohol (400 parts, trade name: PVA-145, a product of Kuraray Co., Ltd.), and a small amount of antifoaming agent, dispersing agent and water were added. As a result, a coating solution B′ for ink receiving layer having a solid component concentration of 15% was obtained.

(Preparation of Ink Jet Recording Sheet)

The coating solution B′ for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B′ became 20 g/m, and this was dried to prepare an ink receiving layer B′. Then, “an aqueous solution (1:4 mixed solution, concentration of 3.75%)” of borax-allylamine hydrochloride.diallylamine hydrochloride copolymer (molar ratio of 4:1, and molecular weight of 20,000) was applied so as to be 20 g/m², and the coating solution A′ for ink receiving layer was applied thereon using a wired bar and dried so that the solid component contained in the coating solution A′ became 7 g/m² to obtain ink jet recording sheet.

### Examples 24-36

Ink jet recording sheet was prepared in the same manner as in Example 23 except that the following compound was used instead of allylamine hydrochloride diallylamine hydrochloride copolymer (molar ratio of 4:1, and molecular weight of about 20,000):
In Example 24: allylamine hydrochloride.diallylamine hydrochloride copolymer (molar ratio of 1:1, and molecular weight of about 70,000);
In Example 25: allylamine.diallylamine copolymer (molar ratio of 4:1, and molecular weight of about 20,000);
In Example 26: allylamine.diallylamine copolymer (molar ratio of 1:1, and molecular weight of about 70,000);
In Example 27: allylamine methanesulfonate.diallylamine methanesulfonate copolymer (molar ratio of 1:1, and molecular weight of about 50,000);
In Example 28: vinylamine hydrochloride diallylamine hydrochloride copolymer (molar ratio of 1:1, and molecular weight of about 50,000);
In Example 29: N-vinylacrylamidine hydrochloride.acrylamide copolymer (molar ratio of 2:1, and molecular weight of about 20,000);
In Example 30: polyallylamine hydrochloride (molecular weight of about 60,000);
In Example 31: polydiallyldimethyl ammonium chloride (molecular weight of about 50,000);
In Example 32: dicyandiamide.polyethylene amine polycondensation product (molecular weight of about 10,000);
In Example 33: basic polyaluminum chloride;
In Example 34: basic polyaluminum acetate;
In Example 35: zirconyl acetate; and
In Example 36: basic zirconyl chloride.

### Example 37

Ink jet recording sheets were prepared in the same manner as in Example 23 except that zirconyl ammonium carbonate aqueous solution (concentration of 3.0%) was used instead of the aqueous solution (1:4 mixed solution, concentration of 3.75%) of borax-allylamine hydrochloride.diallylamine hydrochloride copolymer (molar ratio of 4:1, and molecular weight of about 20,000).

### Example 38

Ink jet recording sheets were prepared in the same manner as in Example 23 except that an aqueous solution (1:3 mixed solution, concentration of 3.0%) of borax-allylamine hydrochloride.diallylamine hydrochloride copolymer (molar ratio of 4:1, and molecular weight of about 20,000) was used instead of the aqueous solution (1:4 mixed solution, concentration of 3.75%) of borax-allylamine hydrochloride.diallylamine hydrochloride copolymer (molar ratio of 4:1, and molecular weight of about 20,000).

### Example 39

Ink jet recording sheets were prepared in the same manner as in Example 23 except that an aqueous solution (1:4 mixed solution, concentration of 3.75%, pH thereof was adjusted to be 8.5 using sodium hydroxide) of borax-allylamine hydrochloride.diallylamine hydrochloride copolymer (molar ratio of 4:1, and molecular weight of about 20,000) was used instead of the aqueous solution (1:4 mixed solution, concentration of 3.75%) of borax-allylamine hydrochloride.diallylamine hydrochloride copolymer (molar ratio of 4:1, and molecular weight of about 20,000) and that the outside ink receiving layer was applied so that the coated amount thereof in terms of solid components became 10 g/m².

### Example 40

Ink jet recording sheets were prepared in the same manner as in Example 23 except that an aqueous solution (1:6 mixed solution, concentration of 5.25%, pH thereof was adjusted to be 8.5 using sodium hydroxide) of borax-allylamine hydrochloride.diallylamine hydrochloride copolymer (molar ratio of 4:1, and molecular weight of about 20,000) was used instead of the aqueous solution (1:4 mixed solution, concentration of 3.75%) of borax-allylamine hydrochloride diallylamine hydrochloride copolymer (molar ratio of 4:1, and molecular weight of about 20,000).

### Example 41

Ink jet recording sheets were prepared in the same manner as in Example 23 except that diallyldimethyl ammonium chloride.acrylamide copolymer (molar ratio of 8:1, and molecular weight of about 200,000) was used instead of the N-vinylacrylamidine hydrochloride acrylamide copolymer (molar ratio of 2:1, and molecular weight of about 20,000).

### Example 42

Ink jet recording sheets were prepared in the same manner as in Example 23 except that an aqueous solution (1:4 mixed solution, concentration of 3.75%) of boric acid allylamine hydrochloride diallylamine hydrochloride copolymer (molar ratio of 4:1, and molecular weight of about 20,000) was used instead of the aqueous solution (1:4 mixed solution, concentration of 3.75%, pH of 7.5) of borax-allylamine hydrochloride diallylamine hydrochloride copolymer (molar ratio of 4:1, and molecular weight of about 20,000).

### Example 43

Ink jet recording sheets were prepared in the same manner as in Example 23 except that an aqueous solution (concentration of 3.0%) of allylamine hydrochloride.diallylamine hydrochloride copolymer (molar ratio of 4:1, and molecular weight of about 20,000) was used instead of the aqueous solution (1:4 mixed solution, concentration of 3.75%, pH of 7.5) of borax-allylamine hydrochloride diallylamine hydrochloride copolymer (molar ratio of 4:1, and molecular weight of about 20,000).

### Example 44

(Preparation of Silica Fine Particle Dispersion)

Distilled water was added to silicate soda solution having a SiO₂ concentration of 30% by mass and SiO₂/Na₂O (molar ratio) of 3.1 (a product of Tokuyama Corporation) to prepare diluted silicate soda aqueous solution having SiO₂ concentration of 4.0% by mass, and the aqueous solution was passed through a column filled with a hydrogen cation exchange resin (“Diaion SK-1BH”, a product of Mitsubishi Chemical Corporation) to obtain an active silicate solution. Distilled water (500 g) was introduced to a 5 liter reaction vessel made of glass, which was provided with a reflux, stirrer and thermometer and heated to 100° C. While maintaining the temperature of 100° C., 450 g of the prepared active silicate solution was added at a rate of 1.5 g/min to prepare a seed solution. The average primary particle size of seed particle aggregate in the seed solution was 184 nm.

Then, after 0.9 g of 28% ammonia aqueous solution was added to stabilize the seed solution, 550 g of the prepared active silicate solution was added to the mixture at a rate of 1.5 g/min while maintaining the temperature of 100° C. After the addition was completed, the mixture was refluxed for 9 hours at 100° C. to concentrate the mixture, and a silica fine particle dispersion of 10% by mass was obtained. The average primary particle size, the average secondary particle size, the specific surface area, and the pore volume of the silica fine particle were 11 nm, 130 nm, 257 m²/g, and 1.01 ml/g, respectively.

(Preparation of Coating Solution C′ for Ink Receiving Layer)

To 1,000 parts of the 10% by mass silica fine particle dispersion of 10% by mass obtained as above, 30% aqueous solution of N-vinylacrylamidine hydrochloride.acrylamide copolymer (50 parts, molar ratio of 2:1, and molecular weight of about 20,000) and 850 parts of ion exchanged water were added. The solution was dispersed using an agitating device, and the mixture was treated using a wet type nanomizer. Then, 5% aqueous solution of polyvinyl alcohol (360 parts, trade name: PVA-145, a product of Kuraray Co., Ltd., saponification degree of 99%, and average polymerization degree of 4,500) and a small amount of antifoaming agent, dispersing agent and water were added. As a result, a coating solution C′ for ink receiving layer having a solid component concentration of 8% was obtained.

(Preparation of Ink Jet Recording Sheet)

The coating solution B′ for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution B′ became 20 g/m², and this was dried to prepare an ink receiving layer B′. Then, aqueous solution (1:4 mixture, concentration of 3.75%) of borax-allylamine hydrochloride diallylamine hydrochloride copolymer (molar ratio of 4:1, and molecular weight of about 20,000) was applied so as to be 20 g/m², and the coating solution C′ for ink receiving layer was applied thereon using a wired bar and dried so that the solid component contained in the coating solution C′ became 7 g/m² to obtain ink jet recording sheet.

### Example 45

Ink jet recording sheets were prepared in the same manner as in Example 23 except that 200 g/m² of woodfree paper was used instead of the paper supporting medium in which both surfaces of 180 g/m² base paper were coated by polyethylene resin (thickness of 240 μm, and the polyethylene resin included 15% by mass of anatase titanium dioxide).

### Comparative Example 8

Ink jet recording sheets were prepared in the same manner as in Example 23 except that borax aqueous solution was used instead of the aqueous solution (1:4 mixture, concentration of 3.75%) of borax-allylamine hydrochloride.diallylamine hydrochloride copolymer (molar ratio of 4:1, and molecular weight of about 20,000).

### Comparative Example 9

(Preparation of Coating Solution D′ for Ink Receiving Layer)

To a 20% dispersion of wet process synthesized amorphous silica (500 parts, trade name: Sylojet 703A, a product of Grace Davison Co. Ltd.), 40% aqueous solution of allylamine hydrochloride.diallylamine hydrochloride copolymer (25 parts, molar ratio of 4:1, and molecular weight of about 20,000), and 25 parts of ion exchanged water were added. The solution was dispersed using an agitating device, and the mixture was treated using a wet type nanomizer. Then, a 5% aqueous solution of polyvinyl alcohol (400 parts, trade name: PVA-145, a product of Kuraray Co., Ltd.) and a small amount of antifoaming agent, dispersing agent and water were added. As a result, a coating solution D′ for ink receiving layer having a solid component concentration of 15% was obtained.

(Preparation of Ink Jet Recording Sheet)

The coating solution D′ for ink receiving layer was applied onto a paper supporting medium in which both surfaces of 180 g/m² base paper were coated by polyethylene resin (thickness of 240 μm, and the polyethylene resin included 15% by mass of anatase titanium dioxide) using a wired bar so that the solid component contained in the coating solution D′ became 20 g/m², and this was dried to prepare an ink receiving layer D′. Then, 0.5% borax aqueous coating solution was applied so as to be 20 g/m², and the coating solution A′ for ink receiving layer was applied thereon using a wired bar and dried so that the solid component contained in the coating solution A′ became 7 g/m² to obtain ink jet recording sheet.

Evaluation Method 3:

Using ink jet recording sheet obtained by Examples 23 to 45 and Comparative Examples 8 to 9, ISO-400 image (refer to “Highly Fine Color Digital Standard Image Data ISO/JIS-SCID”, p. 13, Image Title: Portrait, issued by Japanese Standards Association) was printed using Epson Ink jet printer PM-950 and solid printing was carried out so that the optical density of composite black became 1.0. The above-mentioned evaluations of glossiness, cracks, ink absorption, image quality, and high heat and humidity resistance, were made for the obtained ink jet recording sheet. In addition, water resistance of each ink jet recording sheet was evaluated, and the results are tabulated in the following Table 3. Note that the evaluation for the water resistance was made as follows:

(Water Resistance)

Obtained image of ISO-400 and solid printing image of composite black were immersed in water of 25° C. for 24 hours, and then woodfree paper was superimposed thereon for 10 minutes. After this, the level of water resistance in terms of fading color of the image and color transfer was visually observed and evaluated.

(Evaluation Standard):
⊚: absolutely no generation of color fading and color transfer;
◯: some color fading and color transfer but practically no problem;
Δ: color fading and color transfer were observed and practically problematic; and

X: significant color fading and color transfer.

TABLE 3

| | | | Ink | | Temp. & | |
|---|---|---|---|---|---|---|
| | | | absorp- | Image | humid. | Water |
| | Glossiness | Cracks | tion | quality | resistance | resistance |
| Ex. 23 | ⊚ | ⊚ | ⊚ | ⊚ | ⊚ | ◯ |
| Ex. 24 | ⊚ | ⊚ | ⊚ | ⊚ | ⊚ | ◯ |
| Ex. 25 | ⊚ | ⊚ | ⊚ | ⊚ | ◯ | ◯ |
| Ex. 26 | ⊚ | ⊚ | ⊚ | ⊚ | ◯ | ◯ |
| Ex. 27 | ⊚ | ◯ | ⊚ | ⊚ | ◯ | ◯ |
| Ex. 28 | ⊚ | ◯ | ⊚ | ⊚ | ◯ | ◯ |
| Ex. 29 | ⊚ | ◯ | ◯ | ◯ | ◯ | ◯ |
| Ex. 30 | ⊚ | ◯ | ◯ | ⊚ | ◯ | ◯ |
| Ex. 31 | ⊚ | ◯ | ◯ | ⊚ | ◯ | ◯ |
| Ex. 32 | ⊚ | ◯ | ◯ | ◯ | ◯ | ◯ |
| Ex. 33 | ◯ | ◯ | ◯ | ◯ | ⊚ | ◯ |
| Ex. 34 | ◯ | ◯ | ◯ | ◯ | ⊚ | ◯ |
| Ex. 35 | ◯ | ◯ | ◯ | ◯ | ⊚ | ◯ |
| Ex. 36 | ◯ | ◯ | ◯ | ◯ | ⊚ | ◯ |
| Ex. 37 | ◯ | ◯ | ◯ | ◯ | ◯ | ◯ |
| Ex. 38 | ⊚ | ⊚ | ⊚ | ⊚ | ◯ | ◯ |
| Ex. 39 | ⊚ | ⊚ | ⊚ | ⊚ | ⊚ | ⊚ |
| Ex. 40 | ⊚ | ⊚ | ⊚ | ⊚ | ⊚ | ⊚ |
| Ex. 41 | ⊚ | ◯ | ◯ | ⊚ | ◯ | ◯ |
| Ex. 42 | ◯ | ◯ | ⊚ | ⊚ | ⊚ | ◯ |
| Ex. 43 | ◯ | ◯ | ⊚ | ⊚ | ⊚ | ◯ |
| Ex. 44 | ⊚ | ⊚ | ⊚ | ⊚ | ⊚ | ◯ |
| Ex. 45 | ⊚ | ⊚ | ⊚ | ◯ | ⊚ | ◯ |
| C. Ex. 8 | Δ | Δ | Δ | ◯ | X | X |
| C. Ex. 9 | Δ | Δ | Δ | Δ | X | Δ |

As is obvious from the Table 3, the ink jet recording sheet of Examples 23 to 45 of the present invention were excellent in the evaluations of glossiness, cracks, ink absorption, and image quality as well as water resistance, and almost no time-lapse feathering and color fading were observed even under the high temperature and high humidity environment.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

1. Ink jet recording sheet, comprising:
a supporting medium; and
an ink receiving layer including an inorganic fine particle, a cationic polymer, and a binder, said ink receiving layer being disposed on said supporting medium,
wherein an average primary particle size of the inorganic fine particle is 30 nm or less, and
the cationic polymer is a polymer (A) comprising:
at least one structural unit (a1) expressed by a following general formula (1) or (2): 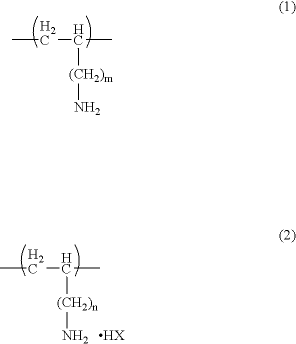
wherein m and n independently represents an integer of 0 to 4, and X represents an acid residue; and
at least one structural unit (a2) expressed by a following general formula (3), (4), (5) or (6): 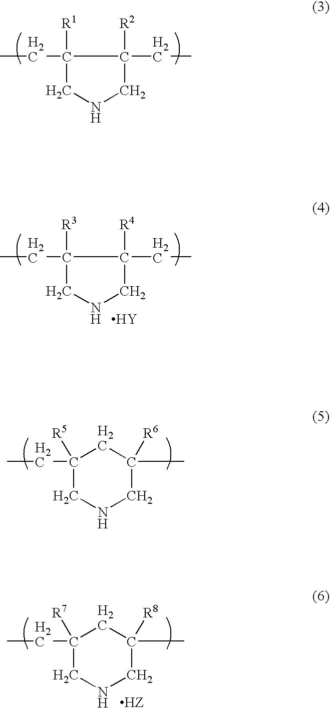
wherein R¹ to R⁸ independently represents a hydrogen atom or an alkyl group having a number of carbon atoms of 1 to 4, and Y, and Z independently represents an acid residue.

2. The ink jet recording sheet according to claim 1, wherein the molar ratio of the structural unit (a1) to the structural unit (a2) in the polymer (A) is within a range of 0.5:1 to 5:1.

3. The ink jet recording sheet according to claim 1, wherein each of m and n in the formula (1) or (2) represents 1.

4. The ink jet recording sheet according to claim 1, wherein each of R¹ to R⁸ in the formula (3), (4), (5) or (6) represents a hydrogen atom.

5. The ink jet recording sheet according to claim 1, wherein the polymer (A) further comprising a structural unit expressed by a following general formula (7):

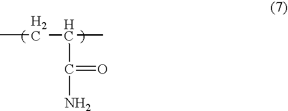

6. The ink jet recording sheet according to claim 1, wherein a total of the structural unit (a1) and the structural unit (a2) in the polymer (A) is 50% by mass or more with respect to the polymer (A).

7. The ink jet recording sheet according to claim 1, wherein a molecular weight of the polymer (A) is within a range of 10,000 to 200,000.

8. The ink jet recording sheet according to claim 1, wherein the inorganic fine particle is vapor phase silica.

9. The ink jet recording sheet according to claim 1, wherein the inorganic fine particle is wet process fine silica prepared by condensing active silica.

10. The ink jet recording sheet according to claim 9, wherein a specific surface area measured by a BET method and a pore volume of the wet process fine silica is 100 to 400 m²/g and 0.5 to 2.0 ml/g, respectively.

11. The ink jet recording sheet according to claim 1, wherein said ink receiving layer further includes a cross-linking agent.

12. The ink jet recording sheet according to claim 11, wherein the cross-linking agent includes a boron compound.

13. The ink jet recording sheet according to claim 12, wherein a mass ratio of the boron compound to the polymer (A) in said ink receiving layer is 1:1 to 1:10.

14. The ink jet recording sheet according to claim 1, wherein said supporting medium is a water resistant supporting medium.

15. The ink jet recording sheet according to claim 14, wherein the water resistant supporting medium is a member at least one surface of which is coated by a polyolefin resin.

16. The ink jet recording sheet according to claim 1, wherein said ink receiving layer is subjected to a cast process.

17. The ink jet recording sheet according to claim 1, further comprising a glossy layer which is disposed on said ink receiving layer.

18. The ink jet recording sheet according to claim 1, wherein said ink receiving layer is made of a plurality of layers comprising:
at least one inside layer including an inorganic fine particle and a binder;
at least one aqueous coating layer formed on the inside layer by applying an aqueous solution including a cationic polymer on the inside layer; and
at least one outside layer disposed on the aqueous coating layer.

19. The ink jet recording sheet according to claim 18, wherein the aqueous solution further includes a cross-linking agent.

20. A method for producing an ink jet recording sheet, comprising the steps of:
forming at least one inside ink receiving layer including an inorganic fine particle and a binder on a supporting medium;
applying an aqueous solution including a cationic compound onto said inside ink receiving layer to form at least one aqueous coating layer; and
forming at least one outside ink receiving layer including an inorganic fine particle and a binder on said aqueous coating layer.

21. The method according to claim 20, wherein the aqueous solution further includes a cross-linking agent.

22. The method according to claim 21, wherein the cross-linking agent includes a boron compound.

23. The method according to claim 20, wherein the cationic compound is at least one selected from the group consisting of a cationic polymer, water soluble aluminum compound, and water soluble zirconyl compound.

24. The method according to claim 20, wherein content of the cationic compound in the aqueous coating layer is 0.01 to 10 g/m².

25. The method according to claim 20, wherein the cationic compound is a polymer (A) comprising:
at least one structural unit (a1) expressed by a following general formula (1) or (2): 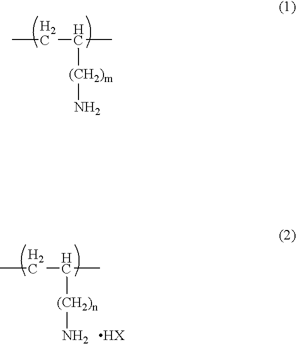
wherein m and n independently represents an integer of 0 to 4, and X represents an acid residue; and
at least one structural unit (a2) expressed by a following general formula (3), (4), (5) or (6): 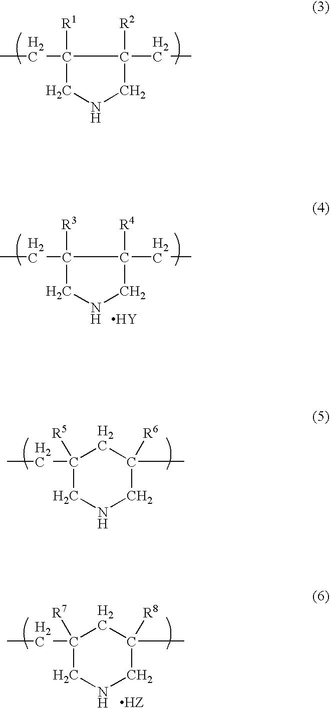
wherein R¹ to R⁸ independently represents a hydrogen atom or an alkyl group having a number of carbon atoms of 1 to 4, and Y and Z independently represents an acid residue.
